(19) United States
(12) Patent Application Publication
(10) Pub. No.: US 2026/0000010 A1
(43) Pub. Date: Jan. 1, 2026

(54) METHOD OF REDUCING HARMFUL GAS EMISSIONS FROM ORGANIC FERTILIZERS

(71) Applicant: Alzchem Trostberg GmbH, Trostberg (DE)

(72) Inventors: Dominik REITER, Palling (DE); Stephan WINKLER, Altenmarkt (DE); Johannes BECHER, Schnaitsee (DE)

(73) Assignee: Alzchem Trostberg GmbH, Trostberg (DE)

(21) Appl. No.: 19/113,114

(22) PCT Filed: Oct. 4, 2023
(86) PCT No.: PCT/EP2023/077461

§ 371 Date: Mar. 19, 2025

(30) Foreign Application Priority Data
Oct. 6, 2022 (DE) 10 2022 125 827.0

(51) Int. Cl. A01C 3/00

(52) U.S. Cl. CPC A01C 3/00

(57) ABSTRACT

The invention relates to a method of reducing emissions of harmful gases from farm manure during storage of same, the method comprising the steps of acidifying the farm manure and adding a cyanamide salt composition to the farm manure.

The present invention relates to a method of reducing emission of harmful gases such as ammonia, carbon dioxide, nitrous oxide, methane and hydrogen sulfide from farm manure during its storage. Furthermore, the present invention relates to the use of a calcium cyanamide (CaCN₂)-containing composition in acidified farm manure, by which emission of these gases during its storage is suppressed or reduced.

In the Federal Republic of Germany, farm manures are considered to be fertilizers that are subject to legal requirements and standards. The application rate and application time of farm manure is often regulated by law. In such a case, farm manures may not be applied to agricultural areas within restricted periods, which, depending on the type of soil and the crop, apply for several months of the year. As a result, livestock-keeping farms are required to provide sufficient storage space for liquid manure, dung water, dung slurry, solid manure, biogas fermentation residues and the like to ensure that farm manures can be stored for a period of at least six months.

Liquid manure, dung water, dung slurry, solid manure, biogas fermentation residues and the like have always been of great importance for agriculture as farm manure. However, due to the concentration of animal agriculture in a limited space, especially in the case of animal housing, these farm manures accumulate in an increased and concentrated form. The storage of these farm manures is also associated with a variety of unresolved problems. For example, during the storage of farm manures, due to microbial, enzymatic metabolic processes from organic substances in the farm manure (aerobic and anaerobic buildup and breakdown processes), environmentally harmful gases such as ammonia (NH₃), carbon dioxide (CO₂), nitrous oxide (N₂O), methane (CH₄) or hydrogen sulfide (H₂S) are produced during the storage of farm manure, sometimes to a considerable extent. The largest amount of methane emitted from farm manure comes from the faeces of cattle—and to a lesser extent pigs.

A number of technical methods are already available to counteract the emission of harmful gases from farm manures. Such measures include, for example, the construction of low-emission open barns, the covering of liquid manure tanks with chopped straw, granulates or floating foils, or, if possible, the direct incorporation of farm manure into the soil. Emissions can also be further reduced with the help of multi-phase feeding low in protein.

A significant reduction in the emission of harmful gases during the storage of farm manures can be achieved by using closed storage containers and processing or destroying the gases that accumulate in the container. However, the equipment required for this is very complex and involves considerable costs.

US 2002/0121117 A1 and US 2014/0311200 A1 describe the use of calcium cyanamide compositions to reduce emission of unpleasant smells from liquid manure.

The use of CaCN₂ to reduce harmful gas emissions during the storage of farm manures is described in WO 2020/099321 A1. The pH value of the farm manure investigated is in the neutral or slightly alkaline range, whereby the pH value of the farm manure is additionally slightly raised by the use of calcium cyanamide.

Furthermore, acidification of farm manures to reduce gas emission from farm manures has been known for a long time (Fangueiro, D. et al. Journal of Environmental Management 2015, 149, 46-56). Controlling the unpleasant smell of liquid manure by using hydrogen peroxide and lowering the pH of liquid manure with mineral acids is described in U.S. Pat. No. 3,966,450. EP 0 612 704 A1 describes the reduction of the emission of ammonia and carbon dioxide from liquid manure by lowering the pH value. A similar method is disclosed in WO 2012/031622 A1 to reduce the emission of methane, ammonia and hydrogen sulfide. In order to improve the practicality of acidification methods, work is still being carried out to optimize them. For example, Dalby F. R. et al. PLoS One 2022, 17(5):e0267693 and Ma C. et al. ACS Agricultural Science & Technology 2022, 2, 437-442 investigate the use of different acids and the optimization of acid dosing quantities. An upstream acid treatment of liquid manure outside the storage tank is also described in EP 2 179 978 A2 in order to achieve an efficient pH value reduction.

However, after acidification of the farm manure, the pH value rises again over time (Overmeyer V. et al. Agronomy 2021, 11, 1319), so that regular pH control and repeated addition of acid to the fertilizer is necessary to maintain effective control over gas formation.

A combination of acidification of the farm manure and additional cyanamide salt treatment is not described in the prior art.

Despite the progress already made in reducing the release of harmful gases from farm manures, there is a great need for methods by which gas emissions can be further reduced. The present invention is therefore based on the problem of providing a method of reducing gas emissions from farm manure during its storage, by means of which the release of a large number of gases is reduced in a sustained manner, is relatively simple to carry out and, moreover, does not negatively impair the planned use of the farm manure as a fertilizer in agriculture. Furthermore, the present invention is intended to reduce the effort required for pH control during the storage of acidified farm manures.

These problems are solved by a combination of acidifying the farm manure until the pH value is in the slightly acidic range and adding a cyanamide salt. This reduces the emission of harmful gases such as NH₃, CO₂, N₂O and CH₄ significantly and for a long time, so that a single application is usually sufficient. In addition, there is a synergistic effect of both measures, whereby the amount of cyanamide salt required to almost completely prevent gas emission can be reduced. More importantly, however, a relatively mild acidification of the farm manure, e.g. to pH 4.5 to pH 6.8, is sufficient so that the amount of acid is significantly reduced. This is also achieved by the fact that repeated acidification over long periods of time can be reduced or completely eliminated by treating the farm manure with the method according to the invention. Furthermore, the formation and release of H₂S can also be effectively prevented using the method according to the invention. The emission of H₂S is a particular problem in the case of acidification with sulfur-containing acids, such as H₂SO₄.

Thus, the subject matter of the present invention is a method of reducing emission of harmful gases from farm manures during its storage, comprising the following method steps:
a) provision of a farm manure, and
b) acidification of the farm manure until a pH value in the range of pH 4.5 to 6.8 is set, and
c) addition of 0.01 wt. % to 1.0 wt. %, based on the total weight of the farm manure, of a cyanamide salt composition to the farm manure.

In addition to the emission of methane and carbon dioxide, the method according to the invention is particularly effective in reducing the emission of ammonia and nitrous oxide. In addition, the formation and release of toxic hydrogen sulfide is also very effectively prevented, particularly in comparison with pure acidification of liquid manure with sulfuric acid. This is particularly relevant for the protection of humans and animals, as there are still accidents caused by H₂S, which in rare cases can be fatal.

It is particularly surprising that the combination of the addition of cyanamide salt to the farm manure and the acidification of the farm manure has a strong synergistic effect on the reduction of gas emission. The synergistic effect can be seen both in the volume of gas emitted and in the duration of gas emission inhibition. A single application of the method according to the invention at the beginning of storage is generally sufficient to prevent undesired emissions. The amounts of cyanamide salt and acid used can also be reduced by combining the two measures compared to the respective individual measures.

According to the present invention, the term farm manure includes fertilizers according to § 2 (1), (2), (3), (4) and (5) of the Fertilizing Act (DüngG, of 9 Jan. 2009 (BGBI. I p. 54, 136), last amended by Article 1 of the Act of 5 May 2017 (BGBI. I p. 1068)). Thus, according to the present invention, farm manures are fertilizers which,
a) as animal faeces
   aa) in the keeping of animals for the production of food; or
   bb) in the case of other keeping of animals in agriculture or
b) as plant substances in the course of plant production or in agriculture, also in mixtures with each other or after aerobic or anaerobic treatment, are accumulated or are produced.

The term farm manure thus also includes in particular
Solid manure: Farm manure from animal faeces, also with litter, in particular straw, sawdust, peat or other plant material added in the course of animal keeping, or mixed with feed remains, the dry matter content of which exceeds 15 wt. %;
Liquid manure: Farm manure from all animal faeces, even with small amounts of litter or feed remains or addition of water, the dry matter content of which does not exceed 15 wt. %; Liquid manure usually comprises a dry matter content of at least 1 wt. %. Preferably liquid manure comprises a solid content in an amount in the range of 3 to 12 wt. %;
Dung water or dung slurry: Farm manure from animal faeces, which is a mixture of urine and leached fine particles of faeces or litter and water; dung water or slurry may contain small amounts of feed residues and cleaning and precipitation water;
Biogas fermentation residues: Farm manure from residues resulting from the fermentation of organic materials of both plant and animal origin from biogas plants.

The method according to the invention is particularly suitable for reducing gas emissions from liquid farm manures and in particular from liquid manure, dung slurry and/or biogas fermentation residues, which preferably have a dry matter content of not more than 15 wt. %.

Untreated farm manures usually have a pH value in the neutral or slightly alkaline range. Due to the manufacturing process, commercially available calcium cyanamide products often contain a certain amount of calcium oxide or calcium hydroxide. When these products are used to reduce emissions, the pH value of the farm manure is shifted slightly towards higher pH values. To avoid emissions, setting a slightly acidic pH value in the range of 4.5 to 6.8 in the farm manure has proven to be advantageous. In many cases, a pH value in the range of 5.0 to 6.5 is even sufficient to achieve the desired reduction in gas emissions. The pH value is particularly preferably in a range between 4.8 and 6.3, in particular in the range of 5.0 and 6.0.

In principle, all acids or acidic compounds (e.g. CO₂ or acidic reacting salts (Al₂(SO₄)₃, KHSO₄, FeCl₂, etc.) and microorganisms (e.g. acid-forming bacteria) can be used for acidification. Preferred acids are selected from the group of inorganic acids (mineral acids) of sulfuric acid, hydrochloric acid, phosphoric acid, nitric acid, silicic acid and of organic acids, such as formic acid, acetic acid, lactic acid, oxalic acid, citric acid, fumaric acid, benzoic acid and maleic acid, the use of sulfuric acid, hydrochloric acid, acetic acid, citric acid or lactic acid being particularly preferred.

In order to achieve a particularly effective reduction of the emission of harmful gases from the farm manure, the fertilizer must be treated with a cyanamide salt in addition to acidification. Whether the pH value is adjusted first or the treatment with cyanamide salt is carried out first or both at the same time is insignificant. However, it is advantageous if the acidification takes place after the treatment with cyanamide. In principle, the addition of the cyanamide salt composition according to method step c) can take place before, during or after the first filling of the storage device with the farm manure. If the addition takes place before the first filling, the cyanamide salt should be added no earlier than one day before the storage device is filled with the farm manure. The acid can also be added to the storage device, at least partly. However, as the adjustment of the pH value is significantly simplified if the acid is added during or after filling the storage device with farm manure, these alternatives are preferred.

Suitable cyanamide salts include, in particular, calcium cyanamide and magnesium cyanamide, but also the corresponding alkali metal salts, such as sodium cyanamide and potassium cyanamide. Suitable cyanamide salts also include salts of cyanamide derivatives, such as acyl cyanamide salts, in particular acetyl cyanamide salts.

Suitable acyl cyanamide salts are in particular compounds of formula [R—(C═O)—N⁻CN]M⁺, wherein R represents an alkyl radical with 1 to 8 C atoms, in particular with 1-4 C atoms and M represents Na, K, ½ Ca or ½ Mg. Preferably, salts of cyanamide (⁻N═C═N⁻) itself are used. The use of calcium cyanamide is very advantageous, as the salt has been used as an active fertilizer ingredient for many decades. Calcium cyanamide is used as a soil fertilizer for a variety of crops such as corn, potatoes and rice.

During the production of cyanamide salts, a composition is usually obtained that contains some by-products. Thus, a calcium cyanamide composition often comprises other ingredients, such as calcium hydroxide or elemental carbon. Since the production-related by-products are harmless, purification can be dispensed with for the purposes of the present invention. Consequently, compositions comprising cyanamide salts can also be used to reduce gas emissions from farm manure during its storage. Such compositions may furthermore also contain other additives, such as fillers, carrier materials, granulation aids, nitrification inhibitors, dyes, pigments, etc.

The cyanamide salt can, for example, be applied to a carrier material. This carrier material can be a material that is inert for agricultural purposes, an excipient approved for agricultural purposes or a fertilizer. According to the present invention, carbonates, such as calcium carbonate, magnesium carbonate, magnesium hydrogen carbonate, calcium hydrogen carbonate, and/or mineral fertilizers are particularly preferably used as carrier material. These carrier materials can originate from industrial processes and can contain an amount of free carbon, charcoal or graphite.

In the method described herein, cyanamide salt compositions are particularly preferably used comprising
a) a cyanamide salt, in particular calcium cyanamide,
b) optionally at least one compound from the group of carbonates, in particular from the group of magnesium carbonate, magnesium hydrogen carbonate, calcium carbonate, calcium hydrogen carbonate, or mixtures thereof, and
c) further preferably optionally free carbon, charcoal or graphite.

Preferably, compositions are used which contain 10 to 100 wt. % of at least one cyanamide salt, in particular calcium cyanamide, based on the total weight of the composition. Particularly preferred in this regard is a composition containing at least 20 wt. %, more preferably at least 25 wt. %, more preferably at least 30 wt. %, more preferably at least 35 wt. %, more preferably at least 40 wt. %, more preferably at least 45 wt. %, more preferably at least 50 wt. %, and up to 100 wt. %, in particular up to 95 wt. %, in particular up to 80 wt. %, in particular up to 55 wt. %, of cyanamide salt, based on the total weight of the composition.

The amounts of other ingredients or carrier materials can vary. The amount of carbonates, in particular selected from the group consisting of magnesium carbonate, magnesium hydrogen carbonate, calcium carbonate and calcium hydrogen carbonate, or mixtures thereof, is preferably at least 1 wt. %, more preferably at least 5 wt. %, particularly preferably at least 10 wt. % and at the same time at most 50 wt. %, in particular at most 40 wt. %, in particular at most 30 wt. % and particularly preferably at most 25 wt. %, the weight percentages being based on the total weight of the cyanamide salt composition.

The amount of free carbon, charcoal or graphite in the composition can preferably be up to 25 wt. %. However, the amount is in particular between 1 and 20 wt. % and particularly preferably between 5 and 15 wt. %, based on the total weight of the cyanamide salt composition.

Furthermore, the composition may comprise up to 20 wt. % of water, based on the total weight of the cyanamide salt composition, depending on the manufacturing method. Preferably, however, the cyanamide salt composition contains less than 15 wt. %, in particular between 1 and 10 wt. % of water.

Cyanamide salt compositions with a low content of hydroxides, such as calcium or magnesium hydroxide, or hydroxide-free compositions are advantageous, as this reduces the amount of acid required to acidify the farm manure. Since many oxides, such as calcium oxide and magnesium oxide, are converted to the corresponding hydroxides during slaking, it is also advantageous to keep the content of these substances in the compositions low or to eliminate them completely.

The method-related amounts of oxides or hydroxides, in particular from the group consisting of magnesium oxide, magnesium hydroxide, calcium oxide and calcium hydroxide, or mixtures thereof, are frequently 1 wt. % or more and should preferably be less than 25 wt. %, particularly preferably less than 20 wt. %, the weight percentages being based on the total weight of the cyanamide salt composition. However, since a corresponding purification of the cyanamide salt compositions would often be too extensive, such amounts in the composition can be tolerated.

It is therefore particularly preferable to use a composition containing
a) 25 to 95 wt. % of a cyanamide salt, in particular calcium cyanamide, and
b) 1 to 20 wt. % of free carbon, charcoal or graphite, the weight percentages being based in each case on the total weight of the cyanamide salt composition.

Further preferred is the use of cyanamide salt compositions containing
a) 25 to 95 wt. % of cyanamide salt, in particular calcium cyanamide,
b) up to 15 wt. % of free carbon, charcoal or graphite,
c) 1 to 40 wt. % of at least one compound from the group of carbonates, in particular from the group of magnesium carbonate, magnesium hydrogen carbonate, calcium carbonate, calcium hydrogen carbonate or mixtures thereof,
d) less than 20 wt. % of oxides and hydroxides, in particular from the group consisting of magnesium oxide, magnesium hydroxide, calcium oxide and calcium hydroxide or mixtures thereof;
e) up to 15 wt. % of water, each based on the total weight of the cyanamide salt composition.

If the cyanamide salt composition is to be used as granules, a granulation aid, for example from the group of nitrates, in particular selected from the group of calcium nitrate, sodium nitrate, potassium nitrate, magnesium nitrate or mixtures thereof, may be present in a preferred amount of between 0.1 wt. % and 10 wt. %, based on the total weight of the cyanamide salt composition. The nitrate content is particularly preferably below 10 wt. %, more preferably below 5 wt. % or below 2 wt. % and in particular in a range from 0.3 to 1 wt. %.

Consequently, cyanamide salt compositions are further preferred containing
a) 25 to 95 wt. % of a cyanamide salt, in particular calcium cyanamide,
b) up to 15 wt. % of free carbon, charcoal or graphite,
c) 1 to 30 wt. % of at least one compound from the group of carbonates, in particular from the group of magnesium carbonate, magnesium hydrogen carbonate, calcium carbonate, calcium hydrogen carbonate or mixtures thereof,
d) less than 20 wt. % of oxides and hydroxides, in particular from the group consisting of magnesium oxide, magnesium hydroxide, calcium oxide and calcium hydroxide or mixtures thereof;
e) up to 15 wt. % of water,
f) up to 10 wt. % of nitrates,
   each based on the total weight of the cyanamide salt composition.

Particularly preferred are cyanamide salt compositions containing:
a) 50 to 80 wt. % of cyanamide salt, in particular calcium cyanamide,
b) up to 15 wt. % of free carbon, charcoal or graphite,
c) 1 to 25 wt. % of at least one compound from the group of carbonates, in particular from the group of magnesium carbonate, magnesium hydrogen carbonate, calcium carbonate, calcium hydrogen carbonate or mixtures thereof,
d) less than 15 wt. % of oxides and hydroxides, in particular from the group consisting of magnesium oxide, magnesium hydroxide, calcium oxide and calcium hydroxide or mixtures thereof;
e) up to 15 wt. % of water,
f) up to 5 wt. % of nitrates,
   each based on the total weight of the cyanamide salt composition.

An alternative, particularly preferred embodiment of the cyanamide salt composition contains:
a) 35 to 55 wt. % of a cyanamide salt, in particular calcium cyanamide,
b) 5 to 15 wt. % of free carbon, charcoal or graphite,
c) 5 to 30 wt. % of at least one compound from the group of carbonates, in particular from the group of magnesium carbonate, magnesium hydrogen carbonate, calcium carbonate, calcium hydrogen carbonate or mixtures thereof,
d) 1 to 20 wt. % of oxides and hydroxides, in particular from the group consisting of magnesium oxide, magnesium hydroxide, calcium oxide and calcium hydroxide or mixtures thereof;
e) 1 to 15 wt. % of water,
f) 0.1 to 5 wt. % of nitrates,
   each based on the total weight of the cyanamide salt composition.

The cyanamide salt compositions can be used in the form of a solid, in particular in the form of a powder, a granulate, or in the form of a suspension, in particular a suspension of these solids. The acid can already be mixed with the cyanamide salt composition or applied separately.

According to the present invention, 0.01 wt. % to 1.0 wt. %, preferably 0.05 wt. % to 0.8 wt. %, in particular 0.07 wt. % to 0.7 wt. %, based on the total weight of the farm manure, of a cyanamide salt composition is added to the farm manure. It is particularly advantageous if the cyanamide salt composition is added in an amount such that the cyanamide salt is present in an amount of from 0.01 to 1.0 wt. %, preferably from 0.03 wt. % to 0.8 wt. %, particularly preferably from 0.05 wt. % to 0.6 wt. % and in particular from 0.06 wt. % to 0.4 wt. %, based on the total weight of the farm manure.

To carry out the method described, it is advantageous if the farm manure is stored in a closed storage device. A closed storage is understood to mean constructions that allow anaerobic storage or at least partial anaerobic storage. Such storage devices can be storage tanks, storage basins or pits that can be closed mechanically. This can be done, for example, by a tent roof or a concrete ceiling. However, the oxygen seal can also be provided by an aqueous phase or an aqueous supernatant on the surface of the farm manure. However, the disclosed method can also be useful in open storage devices or storage containers that do not have a cover or cannot be closed. To accelerate or improve the effect of the method, sufficient mixing of the cyanamide salt composition with the farm manure should be ensured.

It should be emphasized at this point that the method according to the invention can be carried out in an unlimited selection of storage devices. The size of the storage device is not decisive. Thus, volume X can assume any reasonable size. In particular, X means a volume measured in [m³] that is between 0.001 m³≤X≤20,000 m³, preferably between 0.1 m³≤X≤10,000 m³ and more preferably between 1 m³≤X≤10,000 m³ and particularly preferably between 10 m³≤X≤10,000 m³.

Furthermore, the method described is characterized by the fact that addition of the cyanamide salt composition and the acidification of the farm manure in the storage device can be carried out at a temperature of the farm manure in the range from 0° C. to 60° C. without any problems. The method can therefore be used in both winter and midsummer conditions. In particular, farm manures that originate directly from a fermentation process or are in a secondary fermentation tank after a biogas process can be treated using the described method.

It is advantageous if, during or after acidification or addition of the cyanamide salt composition to the farm manure in the storage device, the latter is circulated with a propeller mixer or with an agitator pump. The storage device can be partially filled or completely filled. Preferably, the storage device should be filled to at least 5 vol. % with the farm manure. In a preferred method, at least 5 vol. % of the farm manure, based on the volume of the storage device, is introduced and the cyanamide salt composition is added and stirred in. Acidification can take place before, after and/or simultaneously with the addition of the cyanamide salt. This may be followed by a further addition of farm manure. Once this addition is complete, the farm manure is circulated again in the storage device.

Multiple treatment with the method according to the invention can also be advantageous, particularly in the case of multiple or continuous inflows of farm manure into the storage device. However, a single treatment with the method according to the invention is usually sufficient, provided that sufficient acidification takes place and a sufficient amount of cyanamide salt is provided with the treatment. Since the gas emissions from the farm manure usually only develop after a few days, the treatment of the farm manure with the method according to the invention can also be carried out with a corresponding time delay after filling the storage device. This is possible in particular when the storage device is completely newly filled. However, it is preferable to treat the farm manure close to the time of filling, in particular if there are already longer stored farm manure residues in the storage device.

Propeller mixers driven by a tractor or an electric motor are suitable for circulating the farm manure in the storage device. Propeller agitators or built-in mixers, each with a submersible motor, which are permanently installed in the storage wall, have proved to be particularly suitable, as have tractor-mounted swing-in, articulated and tower propeller mixers, which are immersed in storage tanks with farm manure. Furthermore, agitator nozzles attached to feed pumps are suitable for circulating the farm manure in the storage device, in particular long-shaft agitator pumps driven by an electric motor or tractor with an agitator nozzle or rotary pumps with a ripper.

According to a preferred embodiment of the method, the addition of the cyanamide salt composition and/or the acidification of the farm manure can be carried out once or in portions. In a particularly preferred embodiment, the addition of the composition and/or the acidification
i) can take place once after or during the filling of the storage device with an initial partial quantity of farm manure, or
(ii) in portions after each partial filling of the storage device; or
(iii) once after or during the complete filling of the storage device with farm manure.

The method according to the invention can also be designed such that the addition of the cyanamide salt composition or the acidification is carried out in portions before, during and after a continuous or portion wise filling of the storage device with farm manure.

In livestock farming, farm manure is often continuously produced and collected in a storage device. Also in this regard, it is possible to use the method according to the invention during or after continuous filling with farm manure.

The exposure time of the cyanamide salt composition in the acidified farm manure is preferably at least 24 hours, particularly preferably more than 30 days, in particular >50 days. However, the storage time can also be significantly longer and, for example, last up to one year or, if desired, even longer.

The treatment of the farm manure with the method according to the invention can also begin some time after the storage device has been filled with the farm manure. Fresh farm manure is often characterized by the fact that the majority of the gas emission only occurs after a storage period of 30 to 60 days. Treatment of the farm manure should therefore preferably take place beforehand. With the method according to the invention, a single treatment of the farm manure is usually sufficient to almost completely avoid gas emissions during storage for at least 6 months, usually even for at least 9 months or over a year. In practice, farm manure is not usually stored for longer periods. Also if the farm manure is treated several times, the gas emissions are permanently reduced.

The method according to the invention can avoid at least 30%, further preferably at least 40%, further preferably at least 50%, further preferably at least 60%, even further preferably at least 70% and particularly preferably at least 80% of the ammonia, carbon dioxide, nitrous oxide, methane and hydrogen sulfide emissions from farm manures compared to untreated farm manure.

Thus, the use of a composition comprising cyanamide salt for reducing the emission of ammonia, carbon dioxide, nitrous oxide, methane and hydrogen sulfide from acidified farm manures during their storage is also subject matter of the present invention.

Furthermore, the addition of the cyanamide salt composition and acidification can also be carried out after the farm manure has been stored for a longer period of time, as significant gas development in the farm manure only begins after some time. Thus, it has been shown that an addition after several weeks of storage of the farm manure also enables a reduction in gas emissions. Thus, the method according to the invention is also suitable for stopping or inhibiting the microbial, enzymatic conversion of organic substrates in farm manures during their storage.

The total amount of cyanamide salt to be used can be varied within relatively wide limits. For example, it has been shown that an amount of 0.5 to 10 kg per 1 m³ based on the total amount of farm manure, in particular from 0.6 to 10 kg per 1 m³ or from 1.0 to 10 kg per 1 m³, in particular from 0.7 to 8 kg per 1 m³ or from 1.0 to 8 kg per 1 m³, particularly preferably from 0.8 to 6 kg per 1 m³ or from 1.0 to 6 kg per 1 m³ and particularly preferably from 1.0 to 5 kg or from 1.0 to 4 kg per 1 m³ can be used and is sufficient to significantly reduce the emission of harmful gases in combination with acidification of the farm manure to pH 4.5 to 6.8. The specified amounts are particularly suitable for eliminating gas emissions from relatively liquid farm manures, such as liquid manure, dung slurry or biogas fermentation residues.

The amount of cyanamide salt required to effectively reduce gas emissions from the farm manure depends in particular on the composition and solids content of the farm manure. It tends to make sense to add larger amounts of cyanamide salt if the solids content is high. Conversely, a low solids content favors the use of smaller amounts of cyanamide salt.

Of particular importance is the fact that farm manure treated in this way does not undergo any significant changes in terms of its nitrogen content. The additional amount of nitrogen introduced can even be further reduced with the method described herein compared to the method described in WO 2020/099321 A1.

This means that the total amount of farm manure to be applied per hectare can remain essentially the same. As a result, farm manures and commonly used nitrogen fertilizers, which have an active profile different from that of farm manures, can be used in unchanged amounts throughout the year without fear of overfertilization. Thus, the application of a cyanamide salt-containing composition incorporated into a farm manure according to the present invention also clearly distinguishes itself from conventional fertilization with calcium cyanamide-containing fertilizers in terms of the total nitrogen applied.

### BRIEF DESCRIPTION OF THE FIGURES

FIGS. 1 to 4 show the time course of total gas emissions, CH₄ emissions, CO₂ emissions and H₂S emissions of untreated cattle liquid manure and cattle liquid manure after acidification and CaCN₂ treatment.

FIGS. 5 to 8 show the time course of total gas emissions, CH₄ emissions, CO₂ emissions and H₂S emissions of acidified cattle liquid manure and cattle liquid manure after acidification and CaCN₂ treatment.

FIGS. 9 to 12 show the time course of total gas emissions, CH₄ emissions, CO₂ emissions and H₂S emissions from cattle liquid manure treated with calcium cyanamide and from cattle liquid manure after acidification and CaCN₂ treatment.

FIGS. 13 to 18 show the time course of total gas emissions, CH₄ emissions, CO₂ emissions, H₂S emissions, NH₃ emissions and N₂O emissions of untreated cattle liquid manure compared to cattle liquid manure after acidification and CaCN₂ treatment.

FIGS. 19 to 24 show the time course of total gas emissions, CH₄ emissions, CO₂ emissions, H₂S emissions, NH₃ emissions and N₂O emissions of acidified cattle liquid manure compared to cattle liquid manure after acidification and CaCN₂ treatment.

FIGS. 25 to 30 show the time course of total gas emissions, CH₄ emissions, CO₂ emissions, H₂S emissions, NH₃ emissions and N₂O emissions of cattle liquid manure treated with calcium cyanamide compared to cattle liquid manure after acidification and CaCN₂ treatment.

### EXAMPLES

Two test series were carried out with cattle liquid manure to record gas emissions during the storage of farm manures. Test variants with different acids, with and without CaCN₂ treatment were investigated.

### 1. Material and Methods

### 1.1 Cattle Liquid Manure:

Fresh cattle liquid manure (farm manure) was obtained from a dairy farm in Bavaria. The cattle liquid manure was neither diluted with rinsing/cleaning water or the like, nor was it contaminated with litter. The cattle liquid manure was taken from the antechamber of the drainage channel in the direction of the liquid manure pit.

The analysis of the untreated cattle liquid manure for the two test series yielded the following values:

TABLE 1
Characteristics of the cattle liquid manures used.

| Parameters | Test series 1 | Test series 2 |
|---|---|---|
| Total nitrogen | 0.45 wt. % | 0.41 wt. % |
| Ammonium nitrogen | 0.20 wt. % | 0.15 wt. % |
| Dry matter content | 8.37 wt. % | 9.38 wt. % |
| pH value | 7.49 | 6.89 |

### 1.2 Acidification of Cattle Liquid Manure:

To acidify the cattle liquid manure, 80 or 95% sulfuric acid (H₂SO₄), 32% hydrochloric acid (HCl), 100% acetic acid (HOAc), 50% citric acid (CA) or 90% lactic acid (LA; racemate of D and L-lactic acid) was used. The cattle liquid manure was mixed with the respective acid while stirring and adjusted to the desired pH value (pH 6.0 or pH 5.5). The pH values were measured using a SevenGo Duo pH/Cond meter SG23 from Mettler Toledo.

### 1.3 Composition of the CaCN₂ Formulations (F1 & F2):

Two compositions comprising calcium cyanamide (CaCN₂) were used to reduce harmful gas emissions during the storage of farm manures. The CaCN₂ formulations (F1 & F2) used in the examples are composed as follows:

TABLE 2
Composition of the CaCN₂ formulations F1 and F2.

| Component | F1 | F2 |
|---|---|---|
| Calcium cyanamide | 45.9 wt. % | 43.6 wt. % |
| Calcium hydroxide | 16.3 wt. % | 16.7 wt. % |
| Calcium carbonate | 9.50 wt. % | 9.84 wt. % |
| Calcium nitrate | 0.97 wt. % | 0.62 wt. % |
| Free carbon | 9.90 wt. % | 11.4 wt. % |
| Magnesium carbonate | 7.60 wt. % | 7.92 wt. % |
| Water | 9.83 wt. % | 9.92 wt. % |

The CaCN₂-containing composition F1 has a total nitrogen content of 18.5% and a cyanamide nitrogen content of 16.1%. The CaCN₂-containing composition F2 has a total nitrogen content of 18.3% and a cyanamide nitrogen content of 15.3%.

### 1.4 General Test Procedure:

In a 6-litre wide-necked polyethylene (PE) container with a tight-fitting lid, a defined amount of the cattle liquid manure (farm manure) according to 1.1 is added either untreated or adjusted to a pH value of 6.0 or 5.5 with one of the acids listed. Then, in some examples, a defined amount of the composition F1 or F2 and thus of CaCN₂ is added and stirred in. More detailed information on the application rates of the farm manure and the additives of the different examples and comparative examples are shown in Table 3. Once all substances have been added and stirred in, the 6-liter wide-necked container is tightly closed. To collect the emitting gases during anaerobic storage, a gas-tight opening is made in the lid of the wide-neck container, to which a gas storage bag (nominal volume 5.6 liters) is connected so that no atmospheric oxygen can enter the wide-neck container. The respective mixture is stored at a temperature of 23±1° C. for a defined period of time. The filled gas storage bag is changed at regular intervals, the collected gas volume is determined volumetrically and the gas composition is analyzed using a biogas measuring device (Optima 7 from MRU Messgeräthe für Rauchgase und Umweltschutz GmbH) and a photoacoustic infrared spectrometer (Innova 1512 from Luma Sense Technologies).

TABLE 3
Test series on gas release during anaerobic
storage of cattle liquid manure.

| | | | |
|---|---|---|---|
| | Cattle liquid | | |
| Example | manure [kg] | Acid [g] | F1/F2 [g] |

Test series 1

| | | | |
|---|---|---|---|
| Control (V1) | 3.05 | — | — |
| H₂SO₄ pH 6.0 + 0.21% F1 (B1) | 3.02 | 24.5 | 6.33 |
| H₂SO₄ pH 5.5 + 0.21% F1 (B2) | 3.00 | 31.2 | 6.31 |
| H₂SO₄ pH 6.0 (V2) | 3.01 | 24.4 | — |
| H₂SO₄ pH 5.5 (V3) | 3.00 | 31.2 | — |
| F1 0.21% (V4) | 3.05 | — | 6.34 |
| F1 0.29% (V5) | 3.04 | — | 8.86 |

Test series 2

| | | | |
|---|---|---|---|
| Control (V6) | 3.00 | — | — |
| H₂SO₄ pH 5.5 + 0.22% F2 (B3) | 3.00 | 16.3 | 6.55 |
| H₂SO₄ pH 5.5 + 0.13% F2 (B4) | 3.00 | 16.4 | 3.93 |
| HCl pH 5.5 + 0.22% F2 (B5) | 3.00 | 35.8 | 6.55 |
| HOAc pH 5.5 + 0.22% F2 (B6) | 3.00 | 22.6 | 6.55 |
| CA pH 5.5 + 0.22% F2 (B7) | 3.00 | 41.5 | 6.55 |
| LA pH 5.5 + 0.22% F2 (B8) | 3.00 | 40.4 | 6.55 |
| H₂SO₄ pH 5.5 (V7) | 3.00 | 17.6 | — |
| F2 0.22% (V8) | 3.00 | — | 6.55 |
| F2 0.13% (V9) | 3.00 | — | 3.94 |

### 2. Determination of Gas Emissions

### 2.1 Test Series 1

### 2.1.1 Comparative Example V1 (Control):

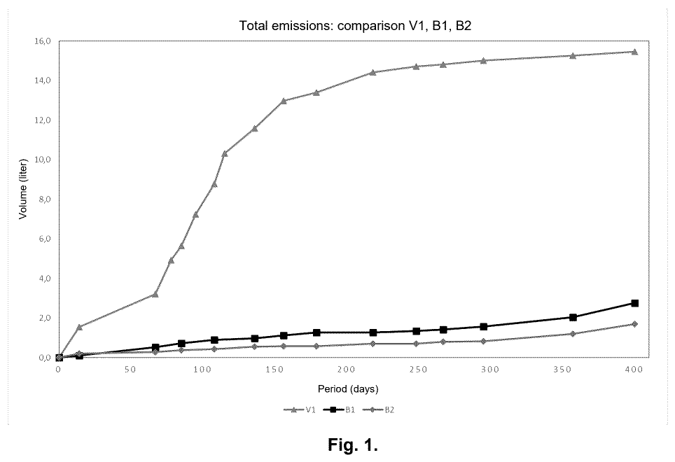

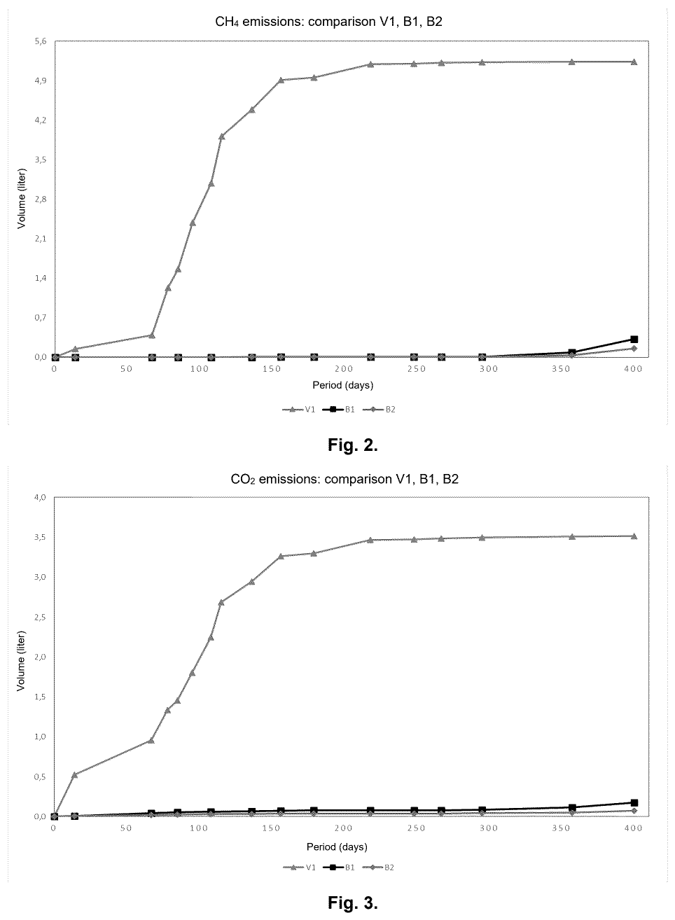

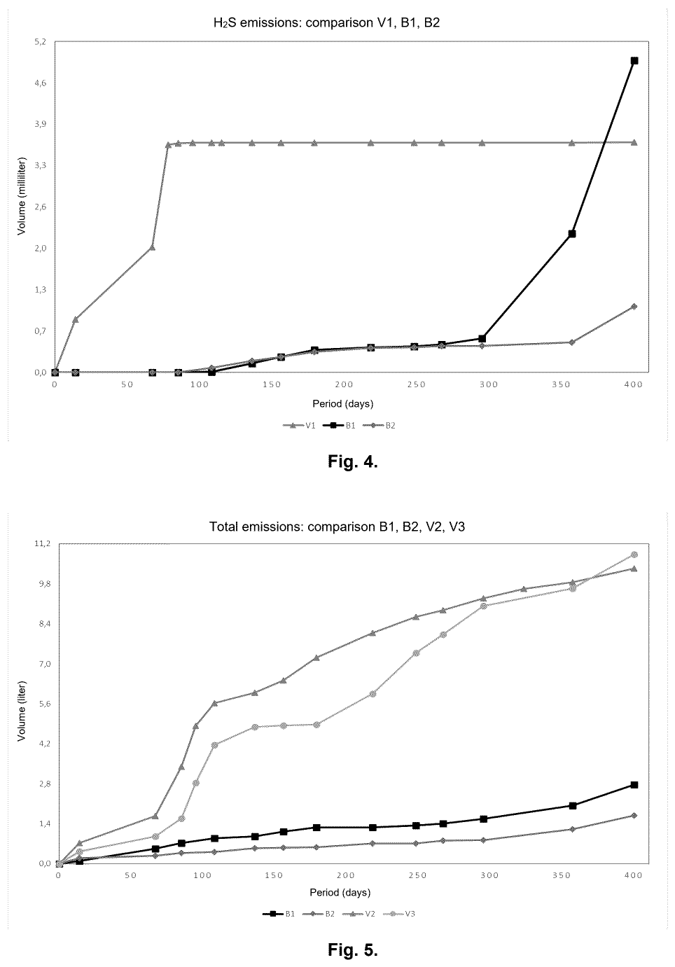

As a reference for the emitted gas quantities during the anaerobic storage of treated farm manure, 3.05 kg of untreated cattle liquid manure without additives was examined (control experiment V1 according to Table 3). The gas storage bags were changed and analyzed after 14, 67, 78, 85, 95, 108, 115, 136, 156, 179, 218, 248, 267, 295, 357 and 400 days. The total gas volume emitted (V_{ges}) and the specific volumes of methane (CH₄), carbon dioxide (CO₂) and hydrogen sulfide (H₂S) are listed cumulatively in Table 4. For better comparability, the determined gas volumes are standardized to 1.00 kg of cattle liquid manure. The development of the respective gases over time is shown in FIGS. 1 to 4.

TABLE 4
Cumulative gas emissions based on 1.00 kg of cattle
liquid manure in liters or milliliters.

| | |
|---|---|
| Storage time | Comparative example V1 |

| [Days] | CH₄ [L] | CO₂ [L] | H₂S [mL] | V_{ges} [L] |
|---|---|---|---|---|
| 14 | 0.14 | 0.52 | 0.83 | 1.54 |
| 67 | 0.39 | 0.96 | 1.97 | 3.20 |
| 78 | 1.23 | 1.33 | 3.57 | 4.92 |
| 85 | 1.56 | 1.45 | 3.60 | 5.63 |
| 95 | 2.38 | 1.81 | 3.61 | 7.24 |
| 108 | 3.08 | 2.25 | 3.61 | 8.78 |
| 115 | 3.92 | 2.69 | 3.61 | 10.3 |
| 136 | 4.38 | 2.94 | 3.61 | 11.6 |
| 156 | 4.91 | 3.26 | 3.61 | 13.0 |
| 179 | 4.96 | 3.30 | 3.61 | 13.4 |
| 218 | 5.19 | 3.46 | 3.61 | 14.4 |
| 248 | 5.20 | 3.47 | 3.61 | 14.7 |
| 267 | 5.22 | 3.49 | 3.61 | 14.8 |
| 295 | 5.23 | 3.50 | 3.61 | 15.0 |
| 357 | 5.23 | 3.51 | 3.61 | 15.3 |
| 400 | 5.24 | 3.51 | 3.61 | 15.5 |

### 2.1.2 Combination of Acidification and CaCN₂ Treatment of Cattle Liquid Manure (B1 and B2):

According to Example B1 (Table 3), 3.02 kg of cattle liquid manure was adjusted to a pH value of 6.0 with 24.5 g of 80% H₂SO₄. Subsequently, 6.33 g of CaCN₂ formulation F1 was added and stirred in. According to Example B2 (Table 3), 3.00 kg of cattle liquid manure was adjusted to a pH of 5.5 with 31.2 g of 80% H₂SO₄. Subsequently, 6.31 g of CaCN₂ formulation F1 was added and stirred in. The gas storage bags were changed and analyzed for both examples after 14, 67, 85, 108, 136, 156, 179, 218, 248, 267, 295, 357 and 400 days. The total gas volumes emitted (V_{ges}) and the specific volumes of methane (CH₄), carbon dioxide (CO₂) and hydrogen sulfide (H₂S) are listed cumulatively in Table 5. For better comparability, the determined gas volumes are standardized to 1.00 kg of cattle liquid manure. The development of the respective gases over time is shown in FIGS. 1 to 4.

TABLE 5
Cumulative gas emissions based on 1.00 kg of cattle
liquid manure in liters or milliliters.

| | Example B1 | | | | Example B2 | | | |
|---|---|---|---|---|---|---|---|---|
| Storage | (H₂SO₄ pH 6.0 + 0.21% F1) | | | | (H₂SO₄ pH 5.5 + 0.21% F1) | | | |
| duration | CH₄ | CO₂ | H₂S | V_{ges} | CH₄ | CO₂ | H₂S | V_{ges} |
| [Days] | [L] | [L] | [mL] | [L] | [L] | [L] | [mL] | [L] |
| 14 | 0.00 | 0.01 | 0.00 | 0.10 | 0.00 | 0.00 | 0.00 | 0.20 |
| 67 | 0.00 | 0.04 | 0.00 | 0.53 | 0.00 | 0.01 | 0.00 | 0.28 |
| 85 | 0.00 | 0.05 | 0.00 | 0.73 | 0.00 | 0.02 | 0.00 | 0.38 |
| 108 | 0.00 | 0.06 | 0.01 | 0.89 | 0.00 | 0.02 | 0.07 | 0.42 |
| 136 | 0.00 | 0.07 | 0.14 | 0.96 | 0.00 | 0.03 | 0.18 | 0.55 |
| 156 | 0.00 | 0.07 | 0.25 | 1.13 | 0.00 | 0.03 | 0.24 | 0.57 |
| 179 | 0.00 | 0.08 | 0.35 | 1.28 | 0.00 | 0.04 | 0.32 | 0.57 |
| 218 | 0.00 | 0.08 | 0.39 | 1.28 | 0.00 | 0.04 | 0.38 | 0.71 |
| 248 | 0.00 | 0.08 | 0.41 | 1.34 | 0.00 | 0.04 | 0.40 | 0.71 |
| 267 | 0.00 | 0.08 | 0.44 | 1.41 | 0.00 | 0.04 | 0.42 | 0.81 |
| 295 | 0.01 | 0.08 | 0.53 | 1.57 | 0.00 | 0.04 | 0.42 | 0.82 |
| 357 | 0.09 | 0.11 | 2.18 | 2.04 | 0.03 | 0.05 | 0.47 | 1.21 |
| 400 | 0.32 | 0.18 | 4.90 | 2.77 | 0.15 | 0.07 | 1.04 | 1.69 |

### Discussion of the Results:

Total emissions: After 400 days of anaerobic storage, 15.5 L of total gas were released based on 1.00 kg of cattle liquid manure in the reference experiment (V1). Acidification with 80% H₂SO₄ to pH 6.0 and subsequent addition of CaCN₂ (Example 1) can reduce emissions by 82.1% to 2.77 L. An even more effective reduction was achieved by acidification with 80% H₂SO₄ to pH 5.5 and subsequent addition of CaCN₂ (Example 2). Compared to the reference experiment (V1), the total emissions were reduced by 89.1% to 1.69 L.

CH₄ emissions: After 400 days of anaerobic storage, 5.24 L of CH₄ were released based on 1.00 kg of cattle liquid manure in the reference experiment (V1). Acidification to pH 6.0 and subsequent addition of CaCN₂ (Example 1) can reduce emissions by 93.9% to 0.32 L. An even more effective reduction was achieved by acidification to pH 5.5 and subsequent addition of CaCN₂ (Example 2). Compared to the reference experiment (V1), CH₄ emissions were reduced by 97.1% to 0.15 L.

CO₂ emissions: After 400 days of anaerobic storage, 3.51 L of CO₂ were released based on 1.00 kg of cattle liquid manure in the reference experiment (V1). Acidification to pH 6.0 and subsequent addition of CaCN₂ (Example 1) can reduce emissions by 94.9% to 0.18 L. An even more effective reduction was achieved by acidification to pH 5.5 and subsequent addition of CaCN₂ (Example 2). Compared to the reference experiment (V1), CO₂ emissions were reduced by 98.0% to 0.07 L.

H₂S emissions: After 400 days of anaerobic storage, 3.61 mL of H₂S was released based on 1.00 kg of cattle liquid manure in the reference experiment (V1). Acidification to pH 6.0 and subsequent addition of CaCN₂ (Example 1) increased the emissions by 35.7% to 4.90 mL. In contrast, an effective reduction was achieved by acidification to pH 5.5 and subsequent addition of CaCN₂. Compared to the reference experiment, the H₂S emissions were reduced by 71.2% to 1.04 mL.

The combination of liquid manure acidification with H₂SO₄ and subsequent CaCN₂ treatment is therefore a very effective measure for reducing harmful gas emissions, in particular methane and carbon dioxide, when storing farm manure such as cattle liquid manure. Compared to the control experiment (V1) with untreated cattle liquid manure, almost no harmful gas emissions were detected over a period of 400 days. A lower pH value of 5.5 at the beginning of storage results in a 39.0% reduction in total emissions compared to total emissions at pH 6.0. The reduction in harmful CH₄, CO₂ and H₂S emissions by 53.1%, 61.1% and 78.8% respectively is even higher.

An increased potential can only be observed with regard to the formation and release of H₂S, which is due to acidification with H₂SO₄. This introduces additional sulphate (SO₄²⁻) for desulphurization (microbial degradation of SO₄²⁻ by sulphate-reducing bacteria/archaea). The influence of the pH value or the increased sulphate concentration can be further illustrated by comparing the two options of the combination of liquid manure acidification and subsequent CaCN₂ treatment. Despite a slightly increased sulphate input in Example 2, the combination of a low pH value and CaCN₂ treatment can also significantly reduce H₂S emissions. This is also shown by comparative examples V2 and V3.

2.1.3 Acidification of Cattle Liquid Manure with H₂SO₄ (Comparative Examples V2 and V3):

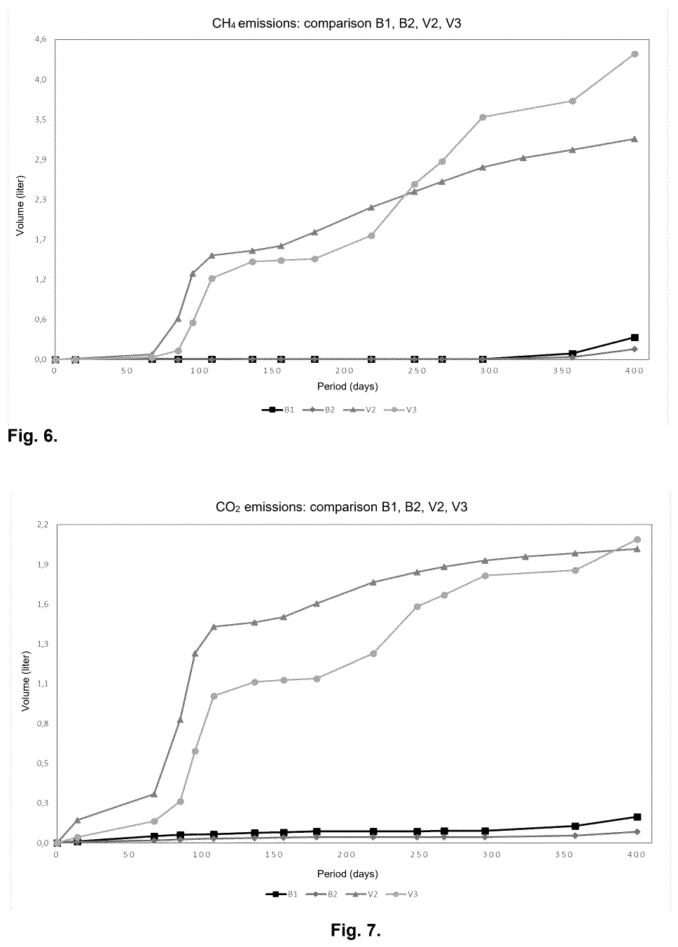

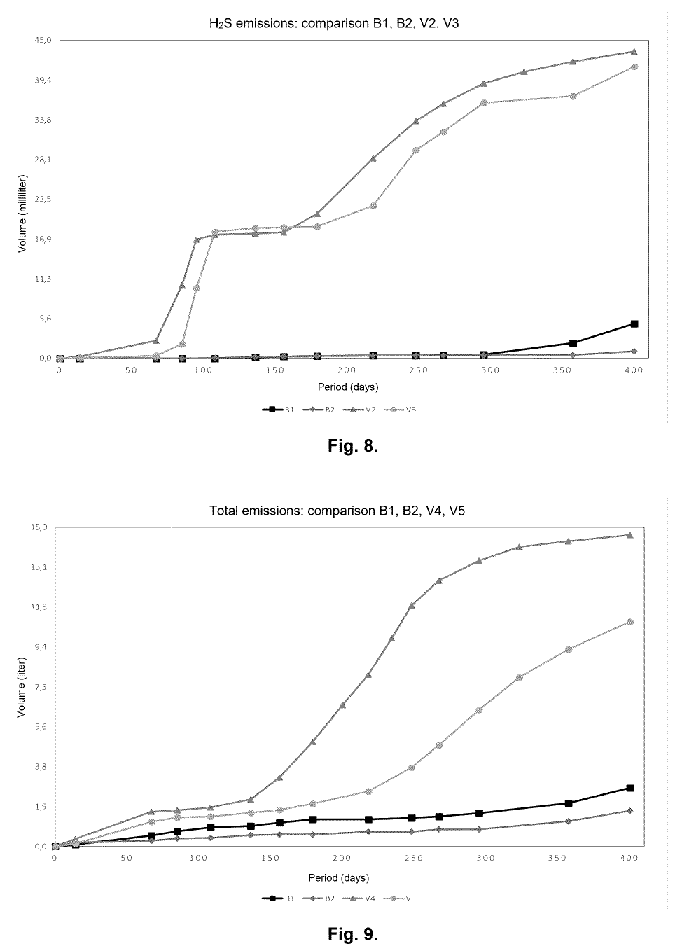

3.01 kg of cattle liquid manure with 24.4 g of 80% H₂SO₄ was adjusted to a pH value of 6.0 (comparative example V2). In comparative example 3, 3.00 kg of cattle liquid manure with 31.2 g of 80% H₂SO₄ was adjusted to a pH value of 5.5. The gas storage bags were changed and analyzed in both comparative examples after 14, 67, 85, 95, 108, 136, 156, 179, 218, 248, 267, 295, 323, 357 and 400 days. The total gas volumes emitted (V_{ges}) and the specific volumes of methane (CH₄), carbon dioxide (CO₂) and hydrogen sulfide (H₂S) are listed cumulatively in Table 6. For better comparability, the determined gas volumes are standardized to 1.00 kg of cattle liquid manure. The development of the respective gases over time is shown in FIGS. 5 to 8.

TABLE 6
Cumulative gas emissions V2 and V3 (based
on 1.00 kg cattle liquid manure).

| | Comparative example V2 | | | | Comparative example V3 | | | |
|---|---|---|---|---|---|---|---|---|
| Storage | (H₂SO₄ pH 6.0) | | | | (H₂SO₄ pH 5.5) | | | |
| duration | CH₄ | CO₂ | H₂S | V_{ges} | CH₄ | CO₂ | H₂S | V_{ges} |
| [Days] | [L] | [L] | [mL] | [L] | [L] | [L] | [mL] | [L] |
| 14 | 0.01 | 0.15 | 0.23 | 0.73 | 0.00 | 0.04 | 0.06 | 0.43 |
| 67 | 0.07 | 0.33 | 2.49 | 1.68 | 0.03 | 0.15 | 0.40 | 0.97 |
| 85 | 0.59 | 0.83 | 10.4 | 3.40 | 0.13 | 0.28 | 2.04 | 1.58 |
| 95 | 1.24 | 1.28 | 16.8 | 4.83 | 0.53 | 0.62 | 9.97 | 2.83 |
| 108 | 1.50 | 1.46 | 17.5 | 5.62 | 1.17 | 0.99 | 17.9 | 4.16 |
| 136 | 1.56 | 1.49 | 17.6 | 5.99 | 1.41 | 1.09 | 18.5 | 4.79 |
| 156 | 1.63 | 1.53 | 17.8 | 6.42 | 1.43 | 1.10 | 18.5 | 4.84 |
| 179 | 1.83 | 1.62 | 20.4 | 7.21 | 1.45 | 1.11 | 18.6 | 4.88 |
| 218 | 2.19 | 1.76 | 28.3 | 8.08 | 1.78 | 1.28 | 21.6 | 5.96 |
| 248 | 2.41 | 1.83 | 33.6 | 8.64 | 2.52 | 1.60 | 29.5 | 7.39 |
| 267 | 2.56 | 1.86 | 36.1 | 8.87 | 2.85 | 1.68 | 32.1 | 8.02 |
| 295 | 2.76 | 1.91 | 38.9 | 9.29 | 3.48 | 1.81 | 36.2 | 9.02 |
| 323 | 2.89 | 1.94 | 40.6 | 9.62 | — | — | — | — |
| 357 | 3.01 | 1.96 | 42.0 | 9.85 | 3.72 | 1.84 | 37.1 | 9.63 |
| 400 | 3.17 | 1.99 | 43.4 | 10.3 | 4.39 | 2.05 | 41.3 | 10.8 |

### Discussion of the Results:

Total emissions: After 400 days of anaerobic storage, 10.3 L of total gas were released based on 1.00 kg of cattle liquid manure in comparative example 2. The additional addition of CaCN₂ (Example 1) can therefore reduce emissions by 73.1% to 2.77 L compared to V2. An even more effective reduction was achieved compared to comparative example 3. Compared to V3, the combination of acidification and subsequent CaCN₂ treatment (Example 2) reduced total emissions from 10.8 L to 1.69 L, i.e. by 84.4%. If no CaCN₂ treatment is carried out, this leads to an increase in total emissions of 272% (acidified cattle liquid manure in V2 compared to Example 1) or 539% (V3 compared to B2). Compared to the reference experiment (V1) with a cumulative total gas volume of 15.5 L based on 1.00 kg of cattle liquid manure, emissions were only reduced by 33.5% (V2) and 30.3% (V3) by acidifying the liquid manure alone.

CH₄ emissions: After 400 days of anaerobic storage, 3.17 L of CH₄ were released based on 1.00 kg of cattle liquid manure in comparative experiment V2. By adding CaCN₂ (Example 1), emissions can be reduced to 0.32 L and thus by 89.9%. If Example 2 is compared with V3, the combination of acidification and subsequent CaCN₂ treatment (B1) reduces CH₄ emissions from 4.39 L to 0.15 L, i.e. by 96.6%. A lack of CaCN₂ treatment, as examined in V2 and V3, resulted in an increase in CH₄ emissions of 891% (compared to Example 1) and 2827% (compared to Example 2). Compared to the reference experiment (V1) with a cumulative CH₄ volume of 5.24 L based on 1.00 kg of cattle liquid manure, CH₄ emissions were only reduced by 39.5% (V2) and 16.2% (V3) by acidifying the liquid manure alone.

CO₂ emissions: After 400 days of anaerobic storage, 1.99 L of CO₂ were released based on 1.00 kg of cattle liquid manure in comparative example V2. In contrast, the addition of CaCN₂ (Example 1) can reduce emissions to 0.18 L and thus by 91.0%. A comparison of Example 2 with V3 shows that the CO₂ emissions were reduced from 2.05 L to 0.07 L and thus by 96.6% through the combination of acidification and subsequent CaCN₂ treatment. Consequently, dispensing with CaCN₂ treatment resulted in an increase in CO₂ emissions of 1006% (compared to B1) and 2829% (compared to B2). Compared to the reference experiment (V1) with a cumulative CO₂ volume of 3.51 L based on 1.00 kg of cattle liquid manure, CO₂ emissions were only reduced by 43.3% (V2) and 41.6% (V3) by acidifying the liquid manure alone.

H₂S emissions: After 400 days of anaerobic storage, 43.4 mL of H₂S were released based on 1.00 kg of cattle liquid manure in comparative example 2. The combination of acidification and addition of CaCN₂ (Example 1) reduces the emissions to 4.90 mL and thus by 88.7%. The comparison of example V3 with Example 2 shows that a reduction in H₂S emissions was achieved by the combination of acidification to pH 5.5 and subsequent CaCN₂ treatment from 41.3 mL to 1.04 mL and thus by 97.5%, i.e. it was even more effective than with pH 6.0. Omitting CaCN₂ treatment caused an increase in H₂S emissions of 786% (compared to B1) and 3871% (compared to B2). Compared to the reference experiment (V1) with a cumulative H₂S volume of 3.61 mL based on 1.00 kg of cattle liquid manure, the H₂S emissions were drastically increased by 1102% (V2) and 1044% (V3) by acidifying the liquid manure alone.

Acidifying the cattle liquid manure alone can already reduce the emission of certain harmful gases, such as methane and CO₂. However, the use of sulfuric acid increases the emission of toxic H₂S due to the sulphate input. With the combined application of acidification and CaCN₂ addition over a period of 400 days, the emission of harmful gases from the farm manure, including hydrogen sulfide, can be significantly reduced compared to acidification alone.

The single application of H₂SO₄ resulted in more than eleven times the amount of H₂S being emitted during anaerobic liquid manure storage than in the control experiment (V1). Consequently, the single acidification of the liquid manure with H₂SO₄ inhibits the general gas emission but seems to support desulfurization and thus the H₂S emission in particular. Additional treatment of cattle liquid manure with CaCN₂ very effectively compensates for this effect and leads to significantly reduced H₂S emissions.

2.1.4 Treatment of Cattle Liquid Manure with CaCN₂ (Comparative Examples V4 and V5):

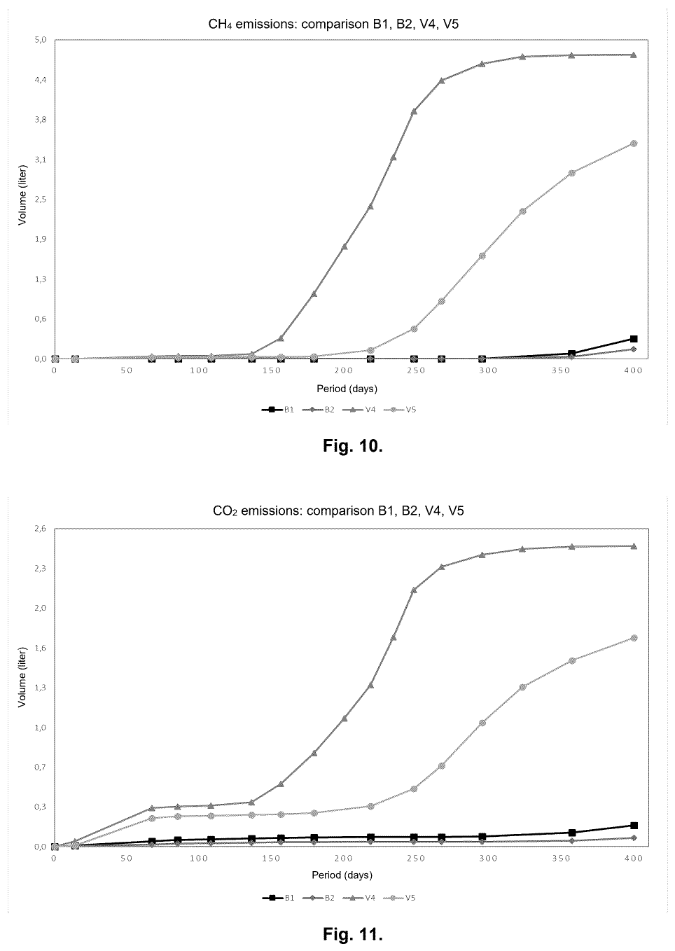

In comparative example V4, 3.05 kg of cattle liquid manure was mixed with 6.34 g of CaCN₂ formulation F1 and stirred in. In comparative example V5, 3.04 kg of cattle liquid manure was mixed with 8.86 g of CaCN₂ formulation F1 and stirred in. The gas storage bags were changed and analyzed in the comparative examples after 14, 67, 85, 108, 136, 156, 179, 200, 218, 234, 248, 267, 295, 323, 357 and 400 days. The total gas volumes emitted (V_{ges}) and the specific volumes of methane (CH₄), carbon dioxide (CO₂) and hydrogen sulfide (H₂S) are listed cumulatively in Table 7. For better comparability, the determined gas volumes are standardized to 1.00 kg of cattle liquid manure. The development of the respective gases over time is shown in FIGS. 9 to 12.

TABLE 7
Cumulative gas emissions in V4 and V5
(based on 1.00 kg cattle liquid manure)

| | Comparative example V4 | | | | Comparative example V5 | | | |
|---|---|---|---|---|---|---|---|---|
| Storage | (CaCN₂ 0.21%) | | | | (CaCN₂ 0.29%) | | | |
| duration | CH₄ | CO₂ | H₂S | V_{ges} | CH₄ | CO₂ | H₂S | V_{ges} |
| [Days] | [L] | [L] | [mL] | [L] | [L] | [L] | [mL] | [L] |
| 14 | 0.00 | 0.04 | 0.00 | 0.36 | 0.00 | 0.01 | 0.00 | 0.15 |
| 67 | 0.04 | 0.32 | 0.01 | 1.64 | 0.02 | 0.23 | 0.00 | 1.17 |
| 85 | 0.04 | 0.33 | 0.01 | 1.71 | 0.03 | 0.25 | 0.00 | 1.36 |
| 108 | 0.05 | 0.34 | 0.01 | 1.85 | 0.03 | 0.26 | 0.00 | 1.43 |
| 136 | 0.08 | 0.36 | 0.01 | 2.21 | 0.03 | 0.26 | 0.00 | 1.59 |
| 156 | 0.32 | 0.51 | 0.01 | 3.26 | 0.03 | 0.27 | 0.00 | 1.72 |
| 179 | 1.02 | 0.76 | 0.01 | 4.94 | 0.04 | 0.28 | 0.00 | 2.02 |
| 200 | 1.77 | 1.05 | 0.01 | 6.64 | — | — | — | — |
| 218 | 2.39 | 1.32 | 0.01 | 8.08 | 0.14 | 0.33 | 0.00 | 2.61 |
| 234 | 3.16 | 1.71 | 0.01 | 9.79 | — | — | — | — |
| 248 | 3.88 | 2.10 | 0.01 | 11.3 | 0.47 | 0.47 | 0.00 | 3.73 |
| 267 | 4.36 | 2.29 | 0.01 | 12.5 | 0.91 | 0.66 | 0.00 | 4.78 |
| 295 | 4.63 | 2.39 | 0.01 | 13.4 | 1.62 | 1.01 | 0.00 | 6.44 |
| 323 | 4.73 | 2.43 | 0.01 | 14.1 | 2.31 | 1.31 | 0.00 | 7.95 |
| 357 | 4.76 | 2.45 | 0.01 | 14.4 | 2.92 | 1.52 | 0.00 | 9.26 |
| 400 | 4.76 | 2.46 | 0.01 | 14.6 | 3.38 | 1.71 | 0.01 | 10.6 |

### Discussion of the Results:

Total emissions: After 400 days of anaerobic storage, 14.6 L of total gas were released based on 1.00 kg of cattle liquid manure in comparative example V4. According to Examples 1 and 2, the additional CaCN₂ treatment reduced emissions by 80.7% to 2.77 L and 88.4% to 1.69 L compared to V4. A comparison of Examples 1 and 2 with V5 shows a reduction in total emissions through the combination of acidification and subsequent CaCN₂ treatment of 10.6 L to 2.77 L and thus by 73.9% and to 1.69 L and thus by 84.1%. If prior liquid manure acidification with H₂SO₄ is omitted, the total emissions increase by 427-764% (comparison of B1 and B2 with V4) or by 283-527% (comparison of B1 and B2 with V5). Compared to the reference experiment (V1) with a cumulative total gas volume of 15.5 L based on 1.00 kg of cattle liquid manure, the emissions were reduced by 5.81% (V4) and 31.6% (V5) by CaCN₂ treatment alone.

CH₄ emissions: After 400 days of anaerobic storage, 4.76 L of CH₄ were released based on 1.00 kg of cattle liquid manure in comparative experiment V4. Additional acidification reduced the emissions to 0.32 L and thus by 93.3% (Example 1) and to 0.15 L and thus by 96.8% (Example 2). A similar reduction results from the comparison of Examples 1 and 2 with example V5. The CH₄ emission from the combination of acidification and subsequent CaCN₂ treatment is reduced from 3.38 L to 0.32 L and thus by 90.5% (Example 1) and to 0.15 L and thus by 95.6% (Example 2). By omitting prior liquid manure acidification with H₂SO₄ as in Examples 1 and 2, CH₄ emissions increase by 1388-3073% and 956-2153% respectively. Compared to the reference experiment (V1) with a cumulative CH₄ volume of 5.24 L based on 1.00 kg of cattle liquid manure, the CaCN₂ treatment alone reduces CH₄ emissions by 9.16% (V4) and 35.5% (V5).

CO₂ emissions: After 400 days of anaerobic storage, 2.46 L of CO₂ were released based on 1.00 kg of cattle liquid manure in comparative experiment V4. Additional acidification reduced the CO₂ emissions to 0.18 L and thus by 92.7% (Example 1) and to 0.07 L and thus by 97.2% (Example 2). A slightly smaller reduction results from the comparison of Examples 1 and 2 with V5. The CO₂ emissions in B1 and B2 fall from 1.71 L to 0.18 L and thus by 89.5% and to 0.07 L and thus by 95.9% respectively compared to V5. The omission of prior liquid manure acidification with H₂SO₄ causes an increase in CO₂ emissions compared to B1 and B2 of 1267-3414% (V4) and 850-2343% (V5). Compared to the reference experiment (V1) with a cumulative CO₂ volume of 3.51 L based on 1.00 kg of cattle liquid manure, CO₂ emissions are reduced by 29.9% (V4) and 51.3% (V5) by CaCN₂ treatment alone.

H₂S emissions: After 400 days of anaerobic storage, 0.01 mL of H₂S was released based on 1.00 kg of cattle liquid manure in each of the comparative experiments V4 and V5. In Examples 1 and 2, the additional acidification increased the emissions to 4.90 mL and 1.04 mL respectively. The omission of prior liquid manure acidification with H₂SO₄ results in a reduction in H₂S emissions of 99.0-99.8% (V4/V5 compared to B1 and B2). Compared to the reference experiment (V1) with a cumulative H₂S volume of 3.61 mL based on 1.00 kg of cattle liquid manure, the H₂S emissions were reduced by 99.7% (V4 and V5) by CaCN₂ treatment alone.

Comparative experiments V4 and V5 also show that the treatment of an acidified farm manure with calcium cyanamide can further reduce harmful gas emissions compared to treatment with CaCN₂ alone. However, the effect of desulphurization is not achieved when CaCN₂ is added alone. Overall, however, the advantages of the synergetic effects of the combined method clearly outweigh the disadvantages, in particular as a stronger H₂S development only sets in relatively late, after more than 300 days, when the cattle liquid manure is stored anaerobically.

### 2.2 Test Series 2

### 2.2.1 Comparison Example V6 (Control):

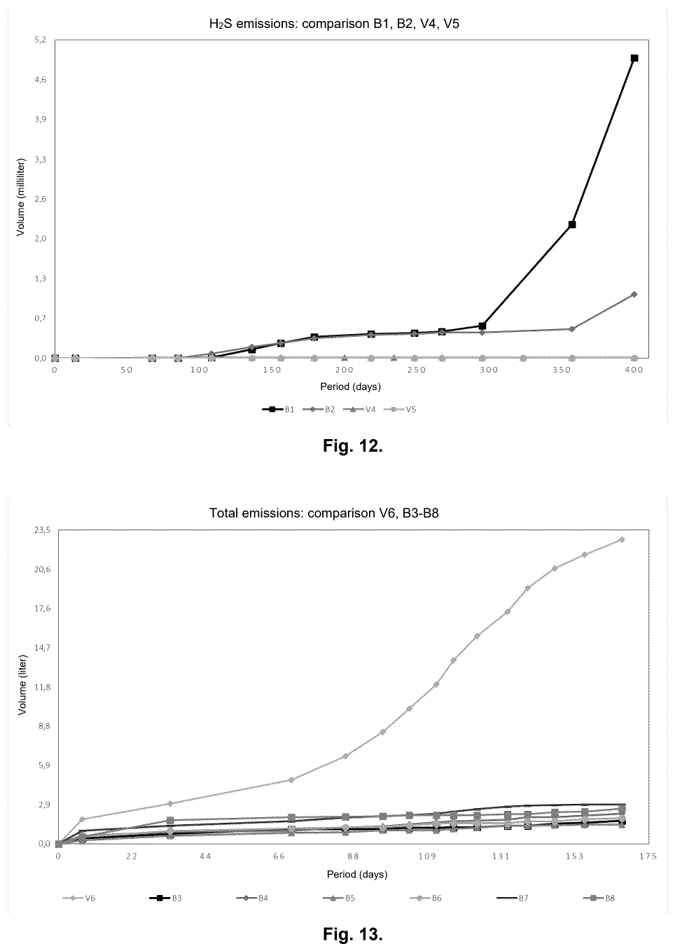

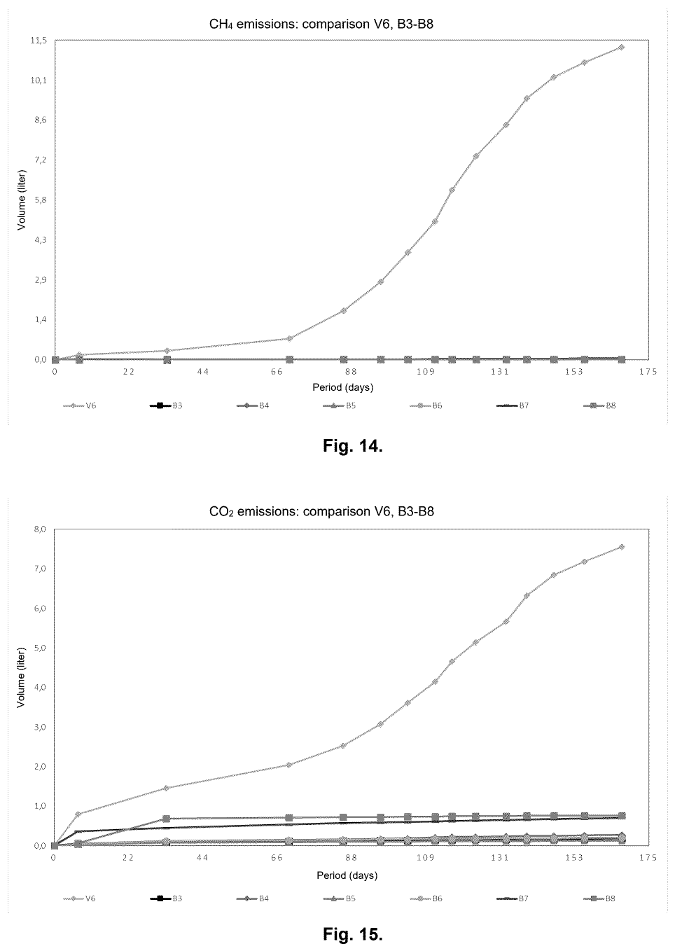

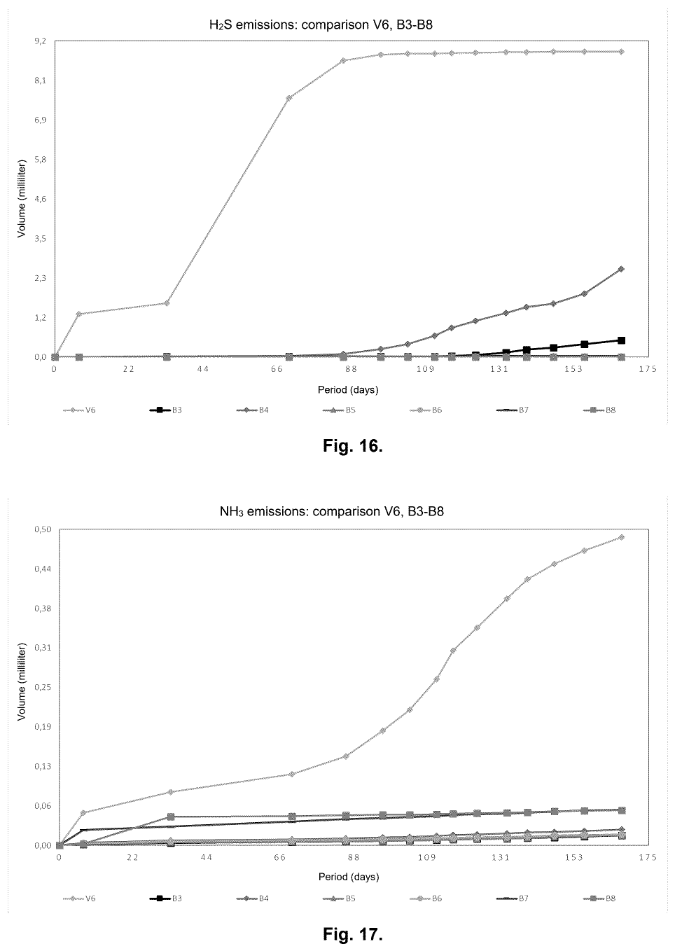

As a reference for the emitted gas quantities during the anaerobic storage of treated farm manure, 3.00 kg of untreated cattle liquid manure without additives was examined (control experiment V6 according to Table 3). The gas storage bags were changed and analyzed after 7, 33, 69, 85, 96, 104, 112, 117, 124, 133, 139, 147, 156 and 167 days. The total volume of gas emitted (V_{ges}) and the specific volumes of methane (CH₄), carbon dioxide (CO₂), hydrogen sulfide (H₂S), ammonia (NH₃) and nitrous oxide (N₂O) are listed cumulatively in Table 8. For better comparability, the gas quantities determined are standardized to 1.00 kg of cattle liquid manure. The development of the respective gases over time is shown in FIGS. 13 to 18.

TABLE 8
Cumulative gas emissions based on 1.00 kg of cattle
liquid manure in liters or milliliters.

| | |
|---|---|
| Storage | Comparative example V6 (control) |

| time | CH₄ | CO₂ | H₂S | NH₃ | N₂O | V_{ges} |
|---|---|---|---|---|---|---|
| [Days] | [L] | [L] | [mL] | [mL] | [mL] | [L] |
| 7 | 0.17 | 0.80 | 1.25 | 0.05 | 0.21 | 1.85 |
| 33 | 0.32 | 1.46 | 1.57 | 0.08 | 0.42 | 3.01 |
| 69 | 0.76 | 2.04 | 7.54 | 0.11 | 0.60 | 4.78 |
| 85 | 1.77 | 2.53 | 8.62 | 0.14 | 0.74 | 6.58 |
| 96 | 2.81 | 3.08 | 8.80 | 0.18 | 0.90 | 8.38 |
| 104 | 3.87 | 3.61 | 8.83 | 0.21 | 1.05 | 10.1 |
| 112 | 4.98 | 4.15 | 8.84 | 0.26 | 1.21 | 12.0 |
| 117 | 6.11 | 4.65 | 8.85 | 0.31 | 1.35 | 13.8 |
| 124 | 7.33 | 5.14 | 8.87 | 0.34 | 1.48 | 15.6 |
| 133 | 8.45 | 5.67 | 8.87 | 0.39 | 1.63 | 17.4 |
| 139 | 9.40 | 6.32 | 8.88 | 0.42 | 1.82 | 19.2 |
| 147 | 10.2 | 6.85 | 8.88 | 0.45 | 1.98 | 20.6 |
| 156 | 10.7 | 7.19 | 8.88 | 0.47 | 2.09 | 21.6 |
| 167 | 11.3 | 7.56 | 8.88 | 0.49 | 2.21 | 22.8 |

### 2.2.2 Combination of Acidification and CaCN₂ Treatment of Cattle Liquid Manure (B3-B8):

According to example B3 (Table 3), 3.00 kg of cattle liquid manure was adjusted to a pH of 5.5 with 16.3 g of 95% H₂SO₄. Subsequently, 6.55 g of CaCN₂ formulation F2 was added and stirred in. According to example B4 (Table 3), 3.00 kg of cattle liquid manure was adjusted to a pH of 5.5 with 16.4 g of 95% H₂SO₄. Subsequently, 3.93 g CaCN₂ formulation F2 was added and stirred in. Furthermore, 3.00 kg of cattle liquid manure was adjusted to a pH value of 5.5 with 35.8 g of 32% hydrochloric acid (HCl, example B5), 22.6 g of 100% acetic acid (HOAc, example B6), 41.5 g of 50% citric acid (CA, example B7) and 40.4 g of 90% lactic acid (LA, example B8) and then 6.55 g of CaCN₂ formulation F2 was added and stirred in. The gas storage bags were changed and analyzed for all examples after 7, 33, 69, 85, 96, 104, 112, 117, 124, 133, 139, 147, 156 and 167 days. The total gas volumes emitted (V_{ges}) and the specific volumes of methane (CH₄), carbon dioxide (CO₂), hydrogen sulfide (H₂S), ammonia (NH₃) and nitrous oxide (N₂O) are listed cumulatively in Tables 9-11. For better comparability, the gas quantities determined are standardized to 1.00 kg of cattle liquid manure. The development of the respective gases over time is shown in FIGS. 13 to 18.

TABLE 9
Cumulative gas emissions based on 1.00 kg of cattle liquid manure in liters or milliliters.

| | Example B3 | | | | | | Example B4 | | | | | |
|---|---|---|---|---|---|---|---|---|---|---|---|---|
| Storage | (H₂SO₄ pH 5.5 + 0.22% F2) | | | | | | (H₂SO₄ pH 5.5 + 0.13% F2) | | | | | |
| duration | CH₄ | CO₂ | H₂S | NH₃ | N₂O | V_{ges} | CH₄ | CO₂ | H₂S | NH₃ | N₂O | V_{ges} |
| [Days] | [L] | [L] | [mL] | [mL] | [mL] | [L] | [L] | [L] | [mL] | [mL] | [mL] | [L] |
| 7 | 0.00 | 0.05 | 0.00 | 0.00 | 0.01 | 0.40 | 0.00 | 0.06 | 0.00 | 0.00 | 0.02 | 0.60 |
| 33 | 0.00 | 0.09 | 0.01 | 0.00 | 0.02 | 0.75 | 0.00 | 0.13 | 0.02 | 0.01 | 0.03 | 0.90 |
| 69 | 0.00 | 0.12 | 0.01 | 0.01 | 0.03 | 1.08 | 0.00 | 0.15 | 0.03 | 0.01 | 0.04 | 0.97 |
| 85 | 0.00 | 0.13 | 0.01 | 0.01 | 0.03 | 1.10 | 0.00 | 0.16 | 0.09 | 0.01 | 0.04 | 1.23 |
| 96 | 0.00 | 0.14 | 0.01 | 0.01 | 0.03 | 1.13 | 0.00 | 0.18 | 0.22 | 0.01 | 0.04 | 1.30 |
| 104 | 0.00 | 0.14 | 0.01 | 0.01 | 0.03 | 1.20 | 0.00 | 0.19 | 0.38 | 0.01 | 0.05 | 1.47 |
| 112 | 0.00 | 0.15 | 0.02 | 0.01 | 0.04 | 1.20 | 0.00 | 0.21 | 0.62 | 0.02 | 0.05 | 1.63 |
| 117 | 0.00 | 0.16 | 0.03 | 0.01 | 0.04 | 1.24 | 0.00 | 0.22 | 0.85 | 0.02 | 0.05 | 1.70 |
| 124 | 0.00 | 0.16 | 0.06 | 0.01 | 0.04 | 1.25 | 0.00 | 0.23 | 1.05 | 0.02 | 0.05 | 1.75 |
| 133 | 0.00 | 0.17 | 0.14 | 0.01 | 0.04 | 1.37 | 0.00 | 0.24 | 1.27 | 0.02 | 0.05 | 1.82 |
| 139 | 0.00 | 0.17 | 0.22 | 0.01 | 0.04 | 1.37 | 0.01 | 0.25 | 1.45 | 0.02 | 0.06 | 1.98 |
| 147 | 0.00 | 0.18 | 0.27 | 0.01 | 0.04 | 1.51 | 0.01 | 0.25 | 1.55 | 0.02 | 0.06 | 1.99 |
| 156 | 0.00 | 0.18 | 0.37 | 0.01 | 0.04 | 1.57 | 0.01 | 0.26 | 1.84 | 0.02 | 0.06 | 2.12 |
| 167 | 0.00 | 0.18 | 0.49 | 0.02 | 0.04 | 1.74 | 0.02 | 0.28 | 2.56 | 0.03 | 0.06 | 2.25 |

TABLE 10
Cumulative gas emissions based on 1.00 kg of cattle liquid manure in liters or milliliters.

| | Example B5 | | | | | | Example B6 | | | | | |
|---|---|---|---|---|---|---|---|---|---|---|---|---|
| Storage | (HCl pH 5.5 + 0.22% F2) | | | | | | (HOAc pH 5.5 + 0.22% F2) | | | | | |
| duration | CH₄ | CO₂ | H₂S | NH₃ | N₂O | V_{ges} | CH₄ | CO₂ | H₂S | NH₃ | N₂O | V_{ges} |
| [Days] | [L] | [L] | [mL] | [mL] | [mL] | [L] | [L] | [L] | [mL] | [mL] | [mL] | [L] |
| 7 | 0.00 | 0.03 | 0.00 | 0.00 | 0.01 | 0.27 | 0.00 | 0.04 | 0.00 | 0.00 | 0.01 | 0.53 |
| 33 | 0.00 | 0.08 | 0.01 | 0.00 | 0.02 | 0.62 | 0.00 | 0.12 | 0.01 | 0.01 | 0.04 | 0.97 |
| 69 | 0.00 | 0.09 | 0.01 | 0.01 | 0.02 | 0.82 | 0.00 | 0.14 | 0.01 | 0.01 | 0.04 | 1.17 |
| 85 | 0.00 | 0.10 | 0.01 | 0.01 | 0.02 | 0.88 | 0.00 | 0.16 | 0.01 | 0.01 | 0.04 | 1.23 |
| 96 | 0.00 | 0.10 | 0.01 | 0.01 | 0.02 | 1.02 | 0.00 | 0.16 | 0.01 | 0.01 | 0.04 | 1.25 |
| 104 | 0.00 | 0.10 | 0.01 | 0.01 | 0.02 | 1.02 | 0.00 | 0.16 | 0.01 | 0.01 | 0.04 | 1.38 |
| 112 | 0.00 | 0.11 | 0.01 | 0.01 | 0.02 | 1.02 | 0.00 | 0.17 | 0.01 | 0.01 | 0.04 | 1.52 |
| 117 | 0.00 | 0.11 | 0.01 | 0.01 | 0.02 | 1.14 | 0.00 | 0.17 | 0.02 | 0.01 | 0.04 | 1.55 |
| 124 | 0.00 | 0.11 | 0.01 | 0.01 | 0.02 | 1.21 | 0.00 | 0.18 | 0.02 | 0.01 | 0.04 | 1.55 |
| 133 | 0.00 | 0.12 | 0.01 | 0.01 | 0.02 | 1.34 | 0.00 | 0.18 | 0.02 | 0.01 | 0.04 | 1.56 |
| 139 | 0.00 | 0.12 | 0.01 | 0.01 | 0.02 | 1.34 | 0.00 | 0.19 | 0.02 | 0.01 | 0.04 | 1.69 |
| 147 | 0.00 | 0.12 | 0.01 | 0.01 | 0.02 | 1.41 | 0.00 | 0.19 | 0.02 | 0.02 | 0.04 | 1.69 |
| 156 | 0.00 | 0.12 | 0.01 | 0.01 | 0.02 | 1.41 | 0.00 | 0.19 | 0.02 | 0.02 | 0.04 | 1.86 |
| 167 | 0.00 | 0.13 | 0.01 | 0.02 | 0.02 | 1.45 | 0.00 | 0.20 | 0.02 | 0.02 | 0.05 | 1.93 |

TABLE 11
Cumulative gas emissions based on 1.00 kg of cattle liquid manure in liters or milliliters.

| | Example B7 | | | | | | Example B8 | | | | | |
|---|---|---|---|---|---|---|---|---|---|---|---|---|
| Storage | (CA pH 5.5 + 0.22% F2) | | | | | | (LA pH 5.5 + 0.22% F2) | | | | | |
| duration | CH₄ | CO₂ | H₂S | NH₃ | N₂O | V_{ges} | CH₄ | CO₂ | H₂S | NH₃ | N₂O | V_{ges} |
| [Days] | [L] | [L] | [mL] | [mL] | [mL] | [L] | [L] | [L] | [mL] | [mL] | [mL] | [L] |
| 7 | 0.00 | 0.36 | 0.00 | 0.02 | 0.13 | 0.97 | 0.00 | 0.06 | 0.00 | 0.00 | 0.02 | 0.53 |
| 33 | 0.00 | 0.45 | 0.01 | 0.03 | 0.15 | 1.35 | 0.00 | 0.69 | 0.00 | 0.05 | 0.22 | 1.78 |
| 69 | 0.01 | 0.54 | 0.01 | 0.04 | 0.17 | 1.68 | 0.00 | 0.71 | 0.00 | 0.05 | 0.22 | 1.98 |
| 85 | 0.01 | 0.57 | 0.01 | 0.04 | 0.18 | 1.95 | 0.00 | 0.72 | 0.00 | 0.05 | 0.22 | 2.05 |
| 96 | 0.02 | 0.59 | 0.01 | 0.04 | 0.18 | 2.08 | 0.00 | 0.73 | 0.00 | 0.05 | 0.22 | 2.07 |
| 104 | 0.02 | 0.60 | 0.02 | 0.04 | 0.18 | 2.15 | 0.00 | 0.73 | 0.01 | 0.05 | 0.22 | 2.13 |
| 112 | 0.02 | 0.61 | 0.02 | 0.05 | 0.19 | 2.25 | 0.00 | 0.74 | 0.01 | 0.05 | 0.23 | 2.14 |
| 117 | 0.02 | 0.62 | 0.02 | 0.05 | 0.19 | 2.42 | 0.00 | 0.74 | 0.01 | 0.05 | 0.23 | 2.15 |
| 124 | 0.03 | 0.63 | 0.02 | 0.05 | 0.19 | 2.62 | 0.00 | 0.75 | 0.01 | 0.05 | 0.23 | 2.16 |
| 133 | 0.03 | 0.65 | 0.02 | 0.05 | 0.19 | 2.78 | 0.00 | 0.75 | 0.01 | 0.05 | 0.23 | 2.22 |
| 139 | 0.03 | 0.66 | 0.02 | 0.05 | 0.19 | 2.88 | 0.00 | 0.76 | 0.01 | 0.05 | 0.23 | 2.23 |
| 147 | 0.04 | 0.67 | 0.03 | 0.05 | 0.20 | 2.92 | 0.00 | 0.76 | 0.01 | 0.05 | 0.23 | 2.36 |
| 156 | 0.04 | 0.68 | 0.03 | 0.06 | 0.20 | 2.95 | 0.00 | 0.76 | 0.01 | 0.05 | 0.23 | 2.43 |
| 167 | 0.05 | 0.70 | 0.03 | 0.06 | 0.20 | 2.95 | 0.00 | 0.76 | 0.01 | 0.06 | 0.23 | 2.63 |

### Discussion of the Results:

Total Emissions, CH₄, CO₂ and H₂S Emissions:

After 167 days of anaerobic storage, 22.8 L of total gas, 11.3 L of CH₄, 7.56 L of CO₂ and 8.88 mL of H₂S were released based on 1.00 kg of cattle liquid manure in the reference experiment V6. Acidification with various acids to pH 5.5 and subsequent addition of CaCN₂ (examples 3-8) can very significantly reduce emissions. Accordingly, the total emissions could be reduced by 87.1-93.7%, the CH₄ emissions by 99.5-100%, the CO₂ emissions by 89.9-98.3% and the H₂S emissions by 71.2-99.9%. The acid used for acidification only plays a subordinate role in the emission reduction effect. However, the use of sulfuric acid (examples 3 and 4) increases H₂S emission due to the additional sulphate input. The influence of the dosing quantity of CaCN₂ (formulation F2) can be seen in examples 3 and 4. The H₂S emissions of 8.88 mL (reference experiment V6) are reduced in example 4 to 2.56 mL (71.2%) and 0.49 mL (94.4%) in example 3.

### Nh₃ Emissions:

After 167 days of anaerobic storage, 0.49 mL of NH₃ was released based on 1.00 kg of cattle liquid manure in the reference experiment (V6). Acidification with various acids to pH 5.5 and subsequent addition of CaCN₂ (examples 3-8) can reduce emissions by 88.4-96.8%.

### N₂O Emissions:

After 167 days of anaerobic storage, 2.21 mL of N₂O was released based on 1.00 kg of cattle liquid manure in the reference experiment (V6). Acidification with various acids to pH 5.5 and subsequent addition of CaCN₂ (examples 3-8) can reduce emissions by 89.7-99.0%.

The test series shows that the combination of liquid manure acidification and subsequent CaCN₂ treatment is a very effective measure for reducing harmful gas emissions when storing farm manures, such as cattle liquid manure. The type of acid used for acidification is less decisive for the reduction of (harmful gas) emissions than the set pH value. In addition, the dosing quantity of CaCN₂ can be reduced in combination with an acid without compromising the reduction in gas emissions compared to treatment with CaCN₂ alone.

2.2.3 Acidification of Cattle Liquid Manure with H₂SO₄ (Comparative Example V7):

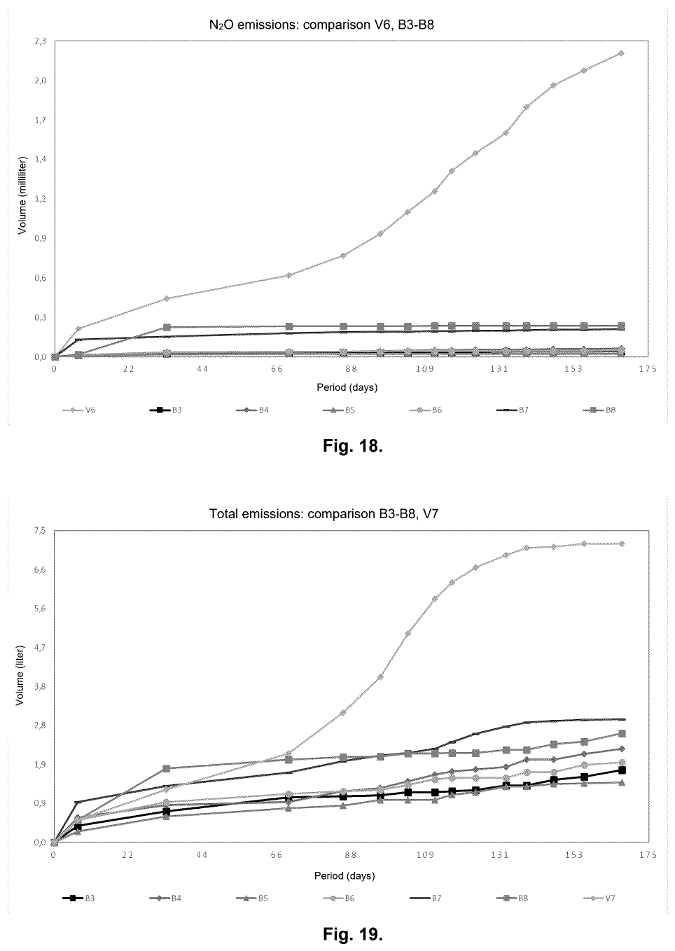

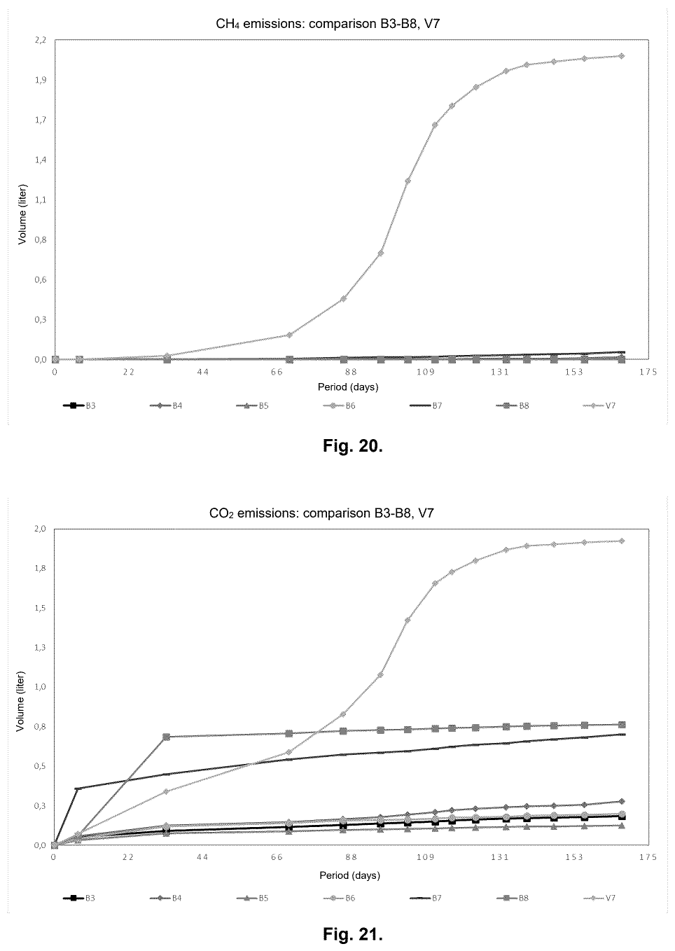

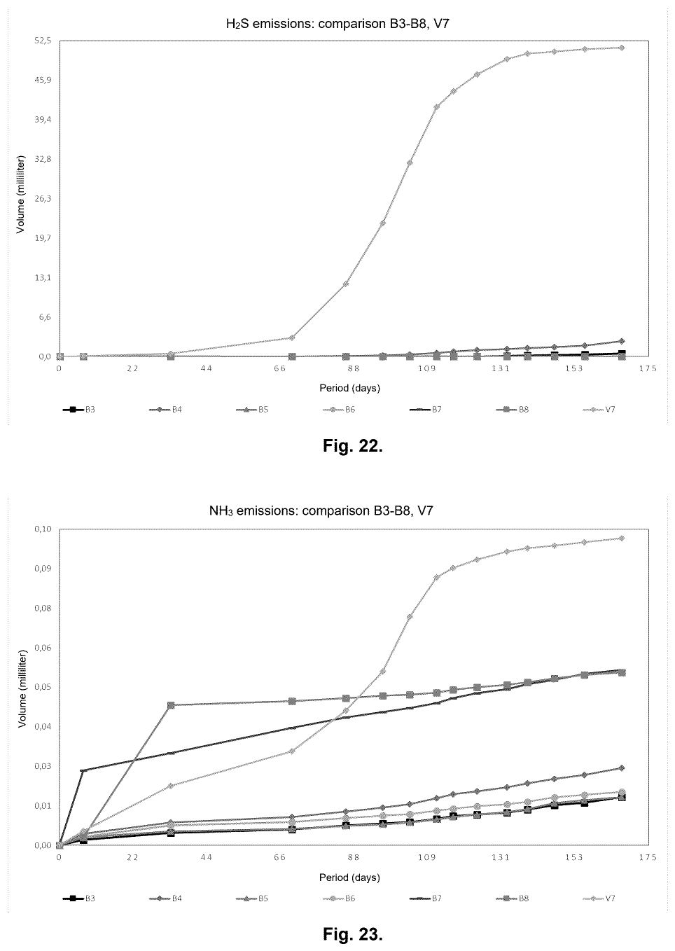

3.00 kg of cattle liquid manure with 17.6 g of 95% H₂SO₄ was adjusted to a pH value of 5.5 (comparative example V7). The gas storage bags were changed and analyzed after 7, 33, 69, 85, 96, 104, 112, 117, 124, 133, 139, 147, 156 and 167 days in the comparative example. The total gas volumes emitted (V_{ges}) and the specific volumes of methane (CH₄), carbon dioxide (CO₂), hydrogen sulfide (H₂S), ammonia (NH₃) and nitrous oxide (N₂O) are listed cumulatively in Table 12. For better comparability, the gas quantities determined are standardized to 1.00 kg of cattle liquid manure. The development of the respective gases over time is shown in FIGS. 19 to 24.

TABLE 12
Cumulative gas emissions V7 (based on 1.00 kg of
cattle liquid manure) in liters or milliliters.

| | Comparative example V7 (H₂SO₄ pH 5.5) | | | | | |
|---|---|---|---|---|---|---|
| Storage time | CH₄ | CO₂ | H₂S | NH₃ | N₂O | V_{ges} |
| [Days] | [L] | [L] | [mL] | [mL] | [mL] | [L] |
| 7 | 0.00 | 0.07 | 0.07 | 0.01 | 0.02 | 0.53 |
| 33 | 0.03 | 0.34 | 0.51 | 0.02 | 0.10 | 1.27 |
| 69 | 0.17 | 0.59 | 3.16 | 0.03 | 0.17 | 2.13 |
| 85 | 0.42 | 0.83 | 12.1 | 0.04 | 0.24 | 3.12 |
| 96 | 0.73 | 1.08 | 22.2 | 0.06 | 0.31 | 3.98 |
| 104 | 1.23 | 1.42 | 32.2 | 0.07 | 0.40 | 5.02 |
| 112 | 1.62 | 1.66 | 41.4 | 0.09 | 0.47 | 5.85 |
| 117 | 1.75 | 1.73 | 44.1 | 0.09 | 0.49 | 6.25 |
| 124 | 1.88 | 1.80 | 46.9 | 0.09 | 0.51 | 6.62 |
| 133 | 1.99 | 1.87 | 49.5 | 0.09 | 0.52 | 6.92 |
| 139 | 2.03 | 1.89 | 50.3 | 0.10 | 0.53 | 7.08 |
| 147 | 2.05 | 1.90 | 50.7 | 0.10 | 0.53 | 7.12 |
| 156 | 2.07 | 1.91 | 51.0 | 0.10 | 0.53 | 7.18 |
| 167 | 2.09 | 1.92 | 51.3 | 0.10 | 0.54 | 7.19 |

### Discussion of the Results:

Total Emissions, CH₄, CO₂ and H₂S Emissions:

After 167 days of anaerobic storage, 7.19 L of total gas, 2.09 L of CH₄, 1.92 L of CO₂ and 51.3 mL of H₂S were released based on 1.00 kg of cattle liquid manure in comparative example V7. By adding CaCN₂ (examples 3-8), a reduction in emissions can be achieved compared to V7. The total emissions could be reduced by 59.0-79.8%, the CH₄ emissions by 97.6-100%, the CO₂ emissions by 60.4-93.2% and the H₂S emissions by 95.0-100%. If no CaCN₂ treatment was carried out, this led to a significant increase in total emissions, including CH₄, CO₂ and H₂S emissions (acidified cattle liquid manure in V7 compared to examples 3-8). Compared to the reference experiment (V6) with cumulative volumes of total gas (22.8 L), CH₄ (11.3 L), CO₂ (7.56 L) and H₂S (8.88 mL) based on 1.00 kg of cattle liquid manure, the emissions were reduced by 68.5% (V_{ges}), 81.4% (CH₄) and 74.6% (CO₂) by the acidification of the liquid manure with sulfuric acid alone and the H₂S emission increased drastically by 477.4%.

### NH₃ Emissions:

After 167 days of anaerobic storage, 0.10 mL of NH₃ was released based on 1.00 kg of cattle liquid manure in comparative example V7. By adding CaCN₂ (examples 3-8), emissions can be reduced to 0.02-0.06 mL and thus by 40.0-80.0%.

### N₂O Emissions:

After 167 days of anaerobic storage, 0.54 mL of N₂O was released based on 1.00 kg of cattle liquid manure in comparative example V7. The combination of acidification and addition of CaCN₂ (examples 3-8) reduces the emissions to 0.02-0.23 mL and thus by 57.4-96.3%.

The findings of the second test series confirm or extend the results from the first test series. For example, the emissions of harmful gases from farm manures can be significantly reduced by a combined application of acidification and CaCN₂ addition compared to acidification alone. In particular when using sulfuric acid, the sometimes considerable H₂S emissions can be compensated for by a low CaCN₂ dosage.

2.2.4 Treatment of Cattle Liquid Manure with CaCN₂ (Comparative Examples V8 and V9):

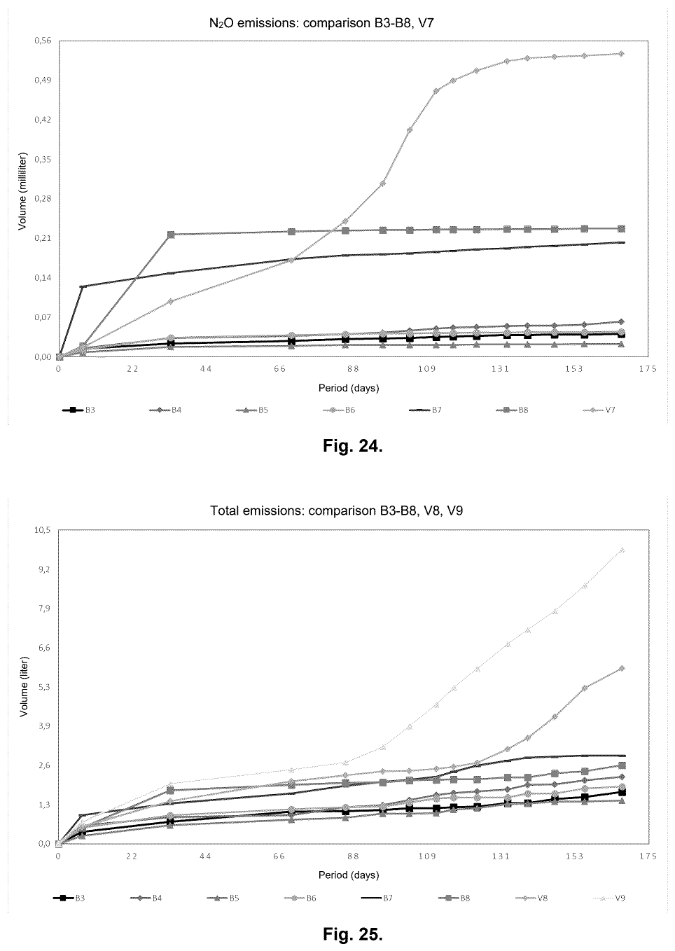

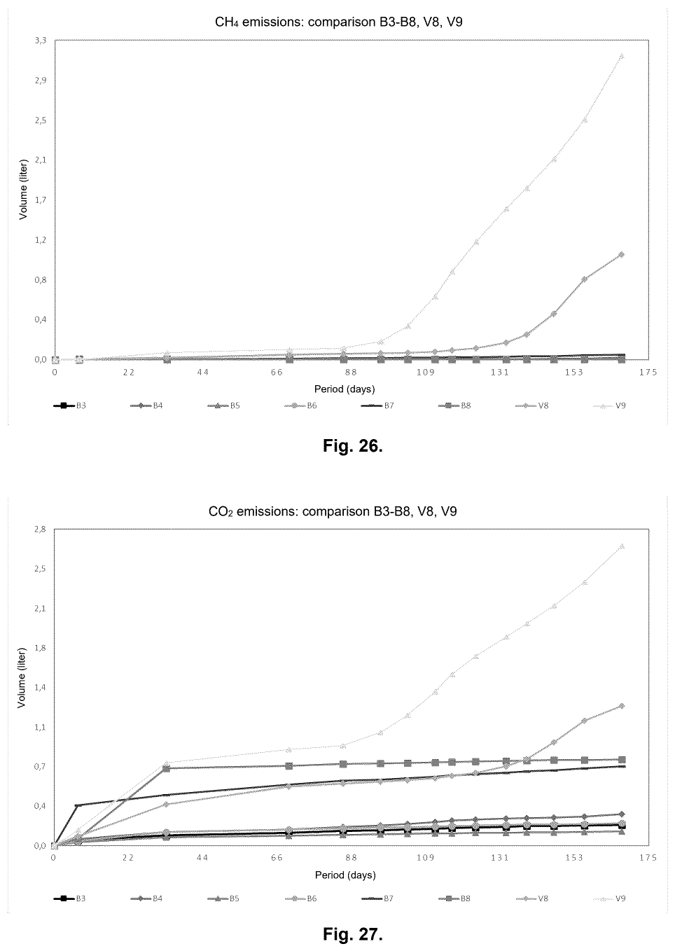

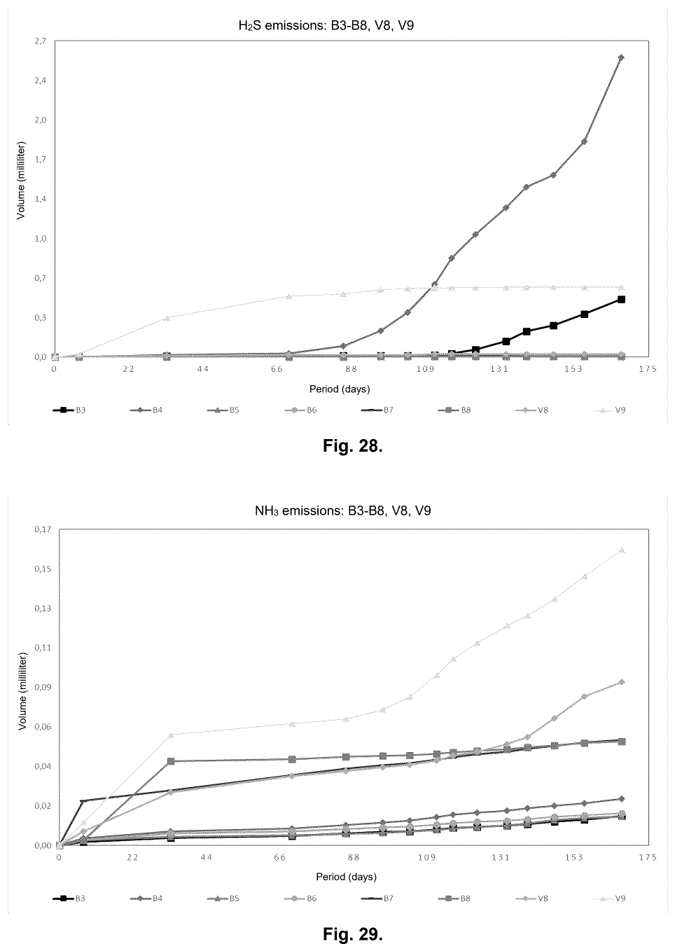

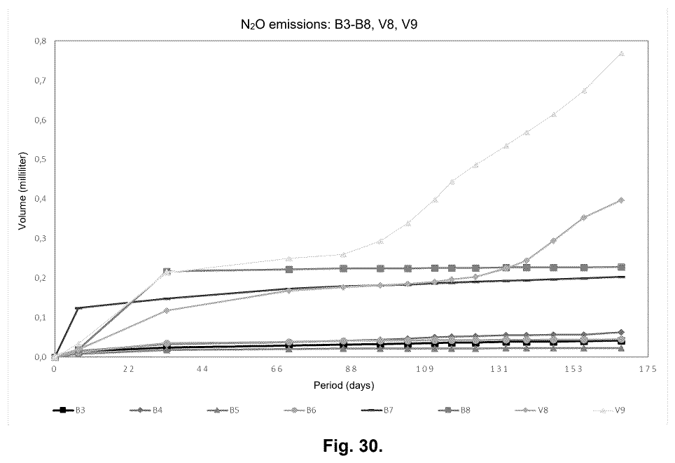

In comparative test V8, 3.00 kg of cattle liquid manure was mixed with 6.55 g of CaCN₂ formulation F2. In comparative test V9, 3.00 kg of cattle liquid manure was mixed with 3.94 g of CaCN₂ formulation F2. The gas storage bags were changed and analyzed in both comparative examples after 7, 33, 69, 85, 96, 104, 112, 117, 124, 133, 139, 147, 156 and 167 days. The total gas volumes emitted (V_{ges}) and the specific volumes of methane (CH₄), carbon dioxide (CO₂), hydrogen sulfide (H₂S), ammonia (NH₃) and nitrous oxide (N₂O) are listed cumulatively in Table 13. For better comparability, the gas quantities determined are standardized to 1.00 kg of cattle liquid manure. The development of the respective gases over time is shown in FIGS. 25 to 30.

TABLE 13
Cumulative gas emissions in V8 and V9 (based on 1.00 kg
of cattle liquid manure) in liters and milliliters.

| | Comparative example V8 | | | | | | Comparative example V9 | | | | | |
|---|---|---|---|---|---|---|---|---|---|---|---|---|
| Storage | (CaCN₂ 0.22%) | | | | | | (CaCN₂ 0.13%) | | | | | |
| duration | CH₄ | CO₂ | H₂S | NH₃ | N₂O | V_{ges} | CH₄ | CO₂ | H₂S | NH₃ | N₂O | V_{ges} |
| [Days] | [L] | [L] | [mL] | [mL] | [mL] | [L] | [L] | [L] | [mL] | [mL] | [mL] | [L] |
| 7 | 0.00 | 0.08 | 0.00 | 0.01 | 0.02 | 0.57 | 0.00 | 0.14 | 0.03 | 0.01 | 0.04 | 0.75 |
| 33 | 0.02 | 0.37 | 0.01 | 0.03 | 0.12 | 1.43 | 0.08 | 0.74 | 0.34 | 0.06 | 0.22 | 2.03 |
| 69 | 0.05 | 0.52 | 0.02 | 0.04 | 0.17 | 2.10 | 0.11 | 0.86 | 0.52 | 0.07 | 0.25 | 2.50 |
| 85 | 0.06 | 0.55 | 0.02 | 0.04 | 0.18 | 2.30 | 0.12 | 0.89 | 0.54 | 0.07 | 0.26 | 2.73 |
| 96 | 0.06 | 0.57 | 0.02 | 0.04 | 0.18 | 2.43 | 0.19 | 1.01 | 0.58 | 0.07 | 0.29 | 3.26 |
| 104 | 0.07 | 0.58 | 0.02 | 0.04 | 0.19 | 2.45 | 0.35 | 1.16 | 0.59 | 0.08 | 0.34 | 3.94 |
| 112 | 0.08 | 0.60 | 0.03 | 0.05 | 0.19 | 2.52 | 0.66 | 1.37 | 0.59 | 0.09 | 0.40 | 4.68 |
| 117 | 0.10 | 0.62 | 0.03 | 0.05 | 0.20 | 2.58 | 0.91 | 1.52 | 0.60 | 0.10 | 0.44 | 5.24 |
| 124 | 0.12 | 0.64 | 0.03 | 0.05 | 0.20 | 2.72 | 1.22 | 1.68 | 0.60 | 0.11 | 0.49 | 5.87 |
| 133 | 0.18 | 0.70 | 0.03 | 0.05 | 0.22 | 3.18 | 1.56 | 1.85 | 0.60 | 0.12 | 0.54 | 6.71 |
| 139 | 0.26 | 0.77 | 0.03 | 0.06 | 0.24 | 3.55 | 1.78 | 1.97 | 0.60 | 0.12 | 0.57 | 7.17 |
| 147 | 0.48 | 0.92 | 0.03 | 0.07 | 0.29 | 4.25 | 2.08 | 2.13 | 0.60 | 0.13 | 0.62 | 7.81 |
| 156 | 0.83 | 1.11 | 0.03 | 0.08 | 0.35 | 5.21 | 2.49 | 2.34 | 0.60 | 0.15 | 0.68 | 8.67 |
| 167 | 1.09 | 1.24 | 0.03 | 0.09 | 0.40 | 5.88 | 3.14 | 2.66 | 0.60 | 0.16 | 0.77 | 9.87 |

### Discussion of the Results:

Total Emissions, CH₄, CO₂ and H₂S Emissions:

After 167 days of anaerobic storage, 5.88 L of total gas, 1.09 L of CH₄, 1.24 L of CO₂ and 0.03 mL of H₂S were released based on 1.00 kg of cattle liquid manure in comparative example V8. Compared to V8, a significant reduction in total emissions (49.8-75.3%), CH₄ emissions (95.4-100%) and CO₂ emissions (38.7-89.5%) were achieved in examples 3 and 5-8. The comparison of V9 and example 4 shows a similar picture, with total emissions being reduced from 9.87 L to 2.25 L (77.2%), CH₄ emissions from 3.14 L to 0.02 L (99.4%) and CO₂ emissions from 2.66 L to 0.28 L (95.1%). If the previous liquid manure acidification is omitted, there is an increase in total emissions, CH₄, CO₂ (comparison of B3-8 with V8 and V9) and H₂S emissions (comparison of B5-8 with V8 and V9). However, due to the absence of sulphate input from sulfuric acid, there is a reduction in H₂S emissions if the acid is omitted (comparison of B3 and B4 with V8 and V9).

### NH₃ Emissions:

After 167 days of anaerobic storage, 0.09 mL of NH₃ was released based on 1.00 kg of cattle liquid manure in comparative example V8. By adding CaCN₂ (examples 3 and 5-8), a reduction in emissions to 0.02-0.06 mL and thus by 33.3-77.8% can be achieved. A comparison of V9 with B4 shows a reduction in NH₃ emissions from 0.16 mL to 0.03 mL, i.e. by 81.3%.

### N₂O Emissions:

After 167 days of anaerobic storage, 0.40 mL of N₂O was released based on 1.00 kg of cattle liquid manure in comparative example V8. The combination of acidification and addition of CaCN₂ (examples 3 and 5-8) reduces the emissions to 0.02-0.23 mL and thus by 42.5-95.0%. The comparison of V9 with B4 reveals a reduction in NH₃ emissions from 0.77 mL to 0.06 mL and thus by 92.2%.

The results of the second test series show that, in addition to the formation and release of the harmful gases CH₄, CO₂ and H₂S, NH₃ and N₂O emissions can also be further reduced by treating an acidified farm manure with calcium cyanamide compared to treatment with CaCN₂ alone. The lower concentrated CaCN₂ treatment (V9/B4) shows similarly good results as the higher dosed option (V8/B3). The combination of liquid manure acidification and CaCN₂ treatment shows a very good effect in terms of gas release even when the CaCN₂ dosage is reduced (B4) and even outperforms the higher concentrated CaCN₂ treatment alone (V8).

2.2.5 Long-Term Measurements within Test Series 2

Test series 2 was continued over a longer period of time until it was completed after 335 days. As an example, the total gas volumes (V_{ges}) and the specific volumes of methane (CH₄), carbon dioxide (CO₂), hydrogen sulfide (H₂S), ammonia (NH₃) and nitrous oxide (N₂O) emitted on two further measurement days, after 268 and 335 days of storage respectively, are listed cumulatively in Table 14.

TABLE 14
Cumulative gas emissions of test series 2 (V6-V9 and B3-B8; based
on 1.00 kg cattle liquid manure) after 268 and 335 days of storage.

| | | | | | | |
|---|---|---|---|---|---|---|
| | CH₄ | CO₂ | H₂S | NH₃ | N₂O | V_{ges} |
| Experiment | [L] | [L] | [mL] | [mL] | [mL] | [L] |

Storage period 268 days

| | | | | | | |
|---|---|---|---|---|---|---|
| Comparative example V6 (control) | 13.5 | 9.19 | 8.88 | 0.57 | 2.76 | 28.4 |
| Comparative example V7 (H₂SO₄ pH 5.5) | 2.91 | 2.23 | 56.9 | 0.11 | 0.62 | 9.19 |
| Comparative example V8 | 4.71 | 3.07 | 0.03 | 0.19 | 0.97 | 14.0 |
| (CaCN₂ 0.22%) | | | | | | |
| Comparative example V9 | 9.10 | 5.40 | 0.60 | 0.33 | 1.55 | 20.4 |
| (CaCN₂ 0.13%) | | | | | | |
| Example B3 | 0.01 | 0.23 | 1.77 | 0.02 | 0.05 | 2.41 |
| (H₂SO₄ pH 5.5 + 0.22% F2) | | | | | | |
| Example B4 | 0.65 | 0.73 | 11.4 | 0.06 | 0.18 | 4.19 |
| (H₂SO₄ pH 5.5 + 0.13% F2) | | | | | | |
| Example B5 | 0.00 | 0.15 | 0.01 | 0.02 | 0.03 | 1.95 |
| (HCl pH 5.5 + 0.22% F2) | | | | | | |
| Example B6 | 0.00 | 0.23 | 0.02 | 0.02 | 0.05 | 2.27 |
| (HOAc pH 5.5 + 0.22% F2) | | | | | | |
| Example B7 | 0.24 | 0.89 | 0.03 | 0.07 | 0.25 | 4.50 |
| (CA pH 5.5 + 0.22% F2) | | | | | | |
| Example B8 | 0.01 | 0.80 | 0.01 | 0.06 | 0.23 | 3.00 |
| (LA pH 5.5 + 0.22% F2) | | | | | | |

Storage period 335 days

| | | | | | | |
|---|---|---|---|---|---|---|
| Comparative example V6 (control) | 13.7 | 9.36 | 8.88 | 0.58 | 2.82 | 29.5 |
| Comparative example V7 (H₂SO₄ pH 5.5) | 5.30 | 3.07 | 76.5 | 0.16 | 0.83 | 12.9 |
| Comparative example V8 | 6.39 | 4.00 | 0.03 | 0.24 | 1.27 | 18.0 |
| (CaCN₂ 0.22%) | | | | | | |
| Comparative example V9 | 9.85 | 5.89 | 0.60 | 0.35 | 1.71 | 22.5 |
| (CaCN₂ 0.13%) | | | | | | |
| Example B3 | 0.23 | 0.39 | 5.45 | 0.03 | 0.09 | 3.84 |
| (H₂SO₄ pH 5.5 + 0.22% F2) | | | | | | |
| Example B4 | 0.83 | 0.81 | 15.2 | 0.06 | 0.19 | 4.59 |
| (H₂SO₄ pH 5.5 + 0.13% F2) | | | | | | |
| Example B5 | 0.01 | 0.16 | 0.01 | 0.02 | 0.03 | 2.35 |
| (HCl pH 5.5 + 0.22% F2) | | | | | | |
| Example B6 | 0.00 | 0.23 | 0.02 | 0.03 | 0.05 | 2.37 |
| (HOAc pH 5.5 + 0.22% F2) | | | | | | |
| Example B7 | 2.24 | 1.93 | 0.04 | 0.13 | 0.52 | 8.87 |
| (CA pH 5.5 + 0.22% F2) | | | | | | |
| Example B8 | 0.01 | 0.81 | 0.01 | 0.07 | 0.23 | 3.07 |
| (LA pH 5.5 + 0.22% F2) | | | | | | |

The long-term measurements show that gas emissions from liquid manure can be greatly reduced in the long term through treatment with calcium cyanamide in combination with acidification of the liquid manure. The long-term measurements also impressively demonstrate the synergistic effect of the two measures.

### SUMMARY OF THE RESULTS

As the examples show, the combination of acidifying farm manure and subsequent CaCN₂ treatment is a very effective measure for reducing harmful gas emissions during the storage of farm manure.

The treatment of farm manures with CaCN₂ alone is already a good measure for reducing harmful gas emissions. Acidification of the farm manure can also reduce gas emissions. However, while the acidification of farm manure is a process that must be applied several times to effectively reduce harmful gas emissions, in combination with CaCN₂ treatment, a single acidification at the beginning of storage is usually sufficient for a long-term reduction in emissions.

Furthermore, a strong synergy effect can be observed in the reduction of gas emissions, in particular in the reduction of harmful ammonia, carbon dioxide, nitrous oxide, methane and hydrogen sulfide releases, when acidification of the farm manure is combined with CaCN₂ treatment. For example, methane emissions after more than 5 months (156 or 167 days) are reduced by 66.8-81.4% (V2, V3 and V7) by acidification alone and by 72.1-99.4% (V4, V5, V8 and V9) by CaCN₂ treatment alone. If both measures are combined, the reduction is 99.5-100% (B1-B8), i.e. higher than would be expected from the individual measures. Acidification alone also leads to a reduction in CO₂ emissions of 53.1-74.6% (V2, V3 and V7). Pure CaCN₂ treatment leads to a reduction of 64.8-91.7% (V4, V5, V8 and V9). If both measures are combined, the reduction is 89.9-99.1% (B1-B8), i.e. better than would be expected from the individual measures. The picture is similar for NH₃ and N₂O emissions. While acidification alone only reduces NH₃ and N₂O releases by 79.7% and 75.7% respectively (V7), the combined process results in reductions of 88.4-96.8% and 89.7-99.0% respectively (B1-B8). In contrast, the use of CaCN₂ alone reduces ammonia and nitrous oxide emissions by 67.4-82.0% and 65.1-82.0% respectively (V8 and V9).

With longer storage times, the synergy effect is even more significant compared to the individual applications. For example, a combination of liquid manure acidification and CaCN₂ treatment after 400 days of storage (B1 and B2) still results in a reduction in CH₄ emissions of 93.9-97.1% and CO₂ emissions of 94.9-98.0%. In contrast, when only one of the two measures was applied, CH₄ and CO₂ emissions were only reduced by 16.2-39.5% and 41.6-43.3% respectively with liquid manure acidification alone (V2 and V3) and by 9.2-35.5% and 29.9-51.3% respectively with CaCN₂ treatment alone (V4 and V5). In general, only negligible emissions were detected after initial adjustment of the pH value of the tested cattle liquid manure to 6.0 or 5.5 and subsequent CaCN₂ treatment during anaerobic storage over a period of 400 days.

In addition, the method according to the invention also shows an excellent effect over a long period of time when setting higher pH values (6.0 vs. 5.5) and at a lower CaCN₂ dosage (0.13% vs. 0.22%). As a result, both the required amount of acid and the dosage of cyanamide salt can be reduced while maintaining an effective reduction in (harmful gas) emissions during the storage of farm manures.

The type of acid used for acidification is hardly relevant for the synergistic effect of the method described herein. However, in addition to ecological (in particular higher H₂S and N₂O emissions due to sulfuric and nitric acid) and economic (price, availability and logistics) factors, safety aspects (sources of danger for humans and animals and material resistance/corrosion) also influence the selection.

1. A method of reducing emission of harmful gases from farm manure during its storage, the method comprising:
a) providing a farm manure,
b) acidifying the farm manure to a pH value in the range from 4.5 to 6.5, and
c) adding 0.01 wt. % to 1.0 wt. %, based on the total weight of the farm manure, of a cyanamide salt composition to the farm manure.

2. The method of claim 1, wherein providing the farm manure occurs before or simultaneously with acidification and addition of the cyanamide salt composition.

3. The method of claim 1, wherein the farm manure is acidified to the pH value in the range from 5.0 to 6.3 in step b).

4. The method of claim 1, wherein step b) is carried out with an acid selected from the group consisting of sulfuric acid, hydrochloric acid, phosphoric acid, nitric acid, silicic acid, formic acid, acetic acid, lactic acid, oxalic acid, citric acid, fumaric acid, benzoic acid, maleic acid, and mixtures thereof.

5. The method of claim 1, wherein the cyanamide salt composition comprises;
a) 25 to 95 wt. % of cyanamide salt,
b) up to 15 wt. % of free carbon, charcoal or graphite,
c) 1 to 40 wt. % of at least one compound comprising carbonates,
d) less than 20 wt. % of oxides and hydroxides,
e) up to 15 wt. % of water,
wherein the percentages by weight in each case is based on the total weight of the cyanamide salt composition.

6. The method of claim 1, wherein a total amount of cyanamide salt added to the farm manure is in the range from 0.5 to 10 kg per 1 m³ based on the total amount of farm manure.

7. The method of claim 1, wherein the farm manure is liquid manure, dung slurry, or biogas fermentation residues.

8. The method of claim 1, wherein the harmful gas is selected from the group consisting of ammonia, carbon dioxide, nitrous oxide, methane and hydrogen sulfide.

9. The method of claim 1, wherein the cyanamide salt composition reduces the emission of harmful gas comprising hydrogen sulfide, and wherein the farm manure is acidified with sulfuric acid.

10. The method of claim 5, wherein the cyanamide salt is calcium cyanamide.

11. The method of claim 5, wherein the carbonates comprise magnesium carbonate, magnesium hydrogen carbonate, calcium carbonate, calcium hydrogen carbonate, or mixtures thereof.

12. The method of claim 5, wherein the oxides and hydroxides are selected from the group consisting of magnesium oxide, magnesium hydroxide, calcium oxide, calcium hydroxide, and mixtures thereof.

13. The method of claim 2, wherein acidification can take place before, after, or simultaneously with addition of the cyanamide salt composition.
